(19) United States
(12) Patent Application Publication
(10) Pub. No.: US 2026/0235976 A1
(43) Pub. Date: Aug. 13, 2026

(54) ELECTROPHOTOGRAPHIC MEMBER, PROCESS CARTRIDGE AND ELECTROPHOTOGRAPHIC IMAGE FORMING APPARATUS

(71) Applicant: CANON KABUSHIKI KAISHA, Tokyo (JP)

(72) Inventors: ATSUSHI UEMATSU, Shizuoka (JP); SATORU NISHIOKA, Shizuoka (JP); YASUHIRO FUSHIMOTO, Kanagawa (JP); MASATSUGU HONGO, Shizuoka (JP); KATSUYA KODAMA, Kanagawa (JP); YUICHI KIKUCHI, Shizuoka (JP); HIROAKI WATANABE, Kanagawa (JP)

(21) Appl. No.: 19/458,172

(22) Filed: Jan. 23, 2026

(30) Foreign Application Priority Data
Jan. 30, 2025 (JP) 2025-014069

(51) Int. Cl. G03G 15/02

(52) U.S. Cl. CPC G03G 15/0233

(57) ABSTRACT

An electrophotographic member containing: a support having a conductive outer surface; an elastic layer provided on the outer surface side of the support; and a surface layer provided on the outer surface of the elastic layer, wherein the elastic layer includes: a matrix containing a first rubber; a plurality of regions B in the matrix; and a plurality of regions C in the matrix, wherein the matrix, the regions B, and the regions C satisfy predetermined requirements, and wherein the regions B include a region B1 that satisfies predetermined requirements.

### BACKGROUND

### Field of the Technology

The present disclosure relates to an electrophotographic member, a process cartridge and an electrophotographic image forming apparatus.

### Description of the Related Art

An electrophotographic image forming apparatus includes, as an electrophotographic member, a charging member, a transfer member, and a developing member. The charging member is a conductive member (the charging member will also be referred to hereinafter as a conductive member) that generates discharge between itself and an electrophotographic photoreceptor, and charges the surface of the electrophotographic photoreceptor. The developing member is a member that controls charging of the developer coated on its surface through triboelectric charging, provides a uniform charge quantity distribution, and uniformly transfers the developer onto the surface of the electrophotographic photoreceptor according to the applied electric field. The transfer member is a member that transfers the developer from the electrophotographic photoreceptor to a print medium such as paper or an intermediate transfer member, and at the same time, generates discharge and stabilizes the developer after transfer.

In an electrophotographic image forming process, the surface of the photosensitive member is charged, the surface of the photosensitive member is then exposed to light to form a latent image, the developing member transfers toner to the latent image on the surface of the photosensitive member, and the transfer member transfers the image onto a paper medium. During transfer onto the paper medium, toner that has not been transferred onto the paper but remains on the photosensitive member (hereinafter referred to as “transfer residual toner”) is removed from the surface of the photosensitive member by scraping it off with a cleaning member. However, when the toner and external additives cannot be completely scraped off with the cleaning member, they may adhere to the surface of the charging member as contaminant substances, the contaminant substances may cause overdischarge, and thus a white speckled image (hereinafter referred to as a “white spot image”) may be formed.

Japanese Patent Laid-Open No. 2021-67946 discloses a charging member that applies uniform charge to contaminant substances adhered to the surface of the charging member, ejects contaminant substances from the surface of the charging member to the surface of the photosensitive member and minimizes accumulation of the contaminant substances on the surface of the charging member. The charging member has a surface layer formed on an elastic layer, and the elastic layer has a matrix-domain structure in which a domain containing a cross-linked product of a second rubber and a conducting agent is dispersed in a matrix containing a cross-linked product of a first rubber.

### SUMMARY

In recent years, the speed and lifespan of electrophotographic image forming processes have been further increased, and in order to reduce the size of the apparatus, an electrophotographic image forming apparatus having a configuration (hereinafter referred to as a “cleanerless configuration”) including no cleaning member for removing the transfer residual toner remaining on the photosensitive member has also been provided. When durability evaluation was performed using the charging member disclosed in Japanese Patent Laid-Open No. 2021-67946 in a higher-speed process and a cleanerless configuration, it was found that accumulation of contaminants became significant even with a number of printed sheets with which accumulation of contaminant substances on the charging member did not previously cause a problem, and white spot images could be formed due to excessive discharge caused by the contaminant substances.

One aspect of the present disclosure is to provide an electrophotographic member that enables high-quality image formation for a long period, even under harsh conditions such as a higher-speed electrophotographic image forming process and a cleanerless configuration, where contaminants accumulate on a charging member. In addition, another aspect of the present disclosure is to provide a process cartridge that contributes to high-quality electrophotographic image formation. In addition, still another aspect of the present disclosure is to provide an electrophotographic image forming apparatus that can form a high-quality electrophotographic image.

According to an aspect of the present disclosure, there is provided an electrophotographic member, comprising: a support having a conductive outer surface; an elastic layer provided on the outer surface side of the support; and a surface layer provided on the outer surface of the elastic layer, wherein the elastic layer includes a matrix containing a first rubber; a plurality of regions B in the matrix; and a plurality of regions C in the matrix, a volume resistivity of the matrix is 1.0×10⁸ to 1.0×10¹² Ω·cm, the region B contains a second rubber different from the first rubber and an electron conducting agent, and has a volume resistivity of 1.0×10⁴ Ω·cm or less, the region C contains a third rubber different from both the first rubber and the second rubber and has a volume resistivity of 1.0×10¹² Ω·cm or more, in cross-sectional observation of a cross section perpendicular to a longitudinal direction of the electrophotographic member, at least a part of the region B includes a region B1, and the region B1 is a domain dispersed in the matrix, in contact with the surface layer, and is a region where the region C exists directly below.

According to another aspect of the present disclosure, there is provided a process cartridge including the electrophotographic member mentioned above.

According to another aspect of the present disclosure, there is provided an electrophotographic image forming apparatus including the electrophotographic member mentioned above.

Features of the present disclosure will become apparent from the following description of embodiments with reference to the attached drawings. The following description of embodiments is described by way of example.

### BRIEF DESCRIPTION OF THE DRAWINGS

FIG. 1A and FIG. 1B are cross-sectional schematic views showing an example of a structure of an elastic layer.

FIG. 2 is a cross-sectional schematic view showing an example of a configuration of a conductive roller.

FIG. 3 is a conceptual diagram illustrating the size of a protruded portion of a surface layer.

FIG. 4 is a diagram showing a schematic configuration of a process cartridge.

FIG. 5 is a diagram showing a schematic configuration of an electrophotographic image forming apparatus.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

The inventors have investigated reasons why, when the charging member disclosed in Japanese Patent Laid-Open No. 2021-67946 had a higher process speed and when the cleanerless configuration was used, accumulation of contaminant substances such as toner and external additives on the charging member became significant even with a number of printed sheets that previously did not cause an image problem, and white spots were formed on an electrophotographic image.

First, the process by which contaminant substances such as toner and external additives adhere to the surface of the charging member will be described. Toner and external additives often have insulating properties because they need to retain a certain charge so that they can be appropriately transferred to the photosensitive member in a development process. Therefore, the contaminant substances such as toner and external additives also have insulating properties. In a developer container, the toner and external additives are charged with a polarity that is strongly biased toward positive or negative. On the other hand, the contaminant substances such as toner and external additives that have not been transferred onto the paper or intermediate transfer member but remain on the photosensitive drum are subjected to rubbing and the like before they reach the charging member, and are therefore charged with a certain distribution with respect to positive and negative polarities. On the other hand, the charging member is configured to generate discharge toward the photosensitive member. Specifically, a DC voltage is applied to the charging member, and a potential difference is generated between the charging member and the surface of the photosensitive member. In this case, with respect to a potential difference between the charging member and the photosensitive member, it is difficult to avoid adhesion of contaminant components having a polarity opposite (positive or negative) to the polarity of the charging bias to the charging member due to electrostatic attraction, and the contaminant substances are transferred from the photosensitive member to the charging member.

Next, a white spot image formed due to abnormal discharge caused by a contaminant substance will be described. A discharge phenomenon occurs between the charging member and the photosensitive member according to Paschen's law, and the surface of the photosensitive member is charged with negative or positive charge depending on the applied voltage. Because discharge is generated when neutral air is ionized by an electric field, charge with the opposite polarity is also generated at the same time. That is, while the photosensitive member is charged with negative or positive charge due to discharge, the electric field enables charge with a polarity opposite to charge that charges the photosensitive member to be drawn toward the charging member. When the charging member is contaminated with an insulating contaminant substance, opposite-polarity charge drawn toward the charging member is trapped on the surface without moving from the surface toward the substrate, and thus the contaminant substance adhered to the surface of the charging member is charged with opposite-polarity charge. Between the contaminant substance charged with opposite-polarity charge and the region surrounding the region to which the contaminant substance is adhered, opposite-polarity charge is generated in a very short distance. Therefore, a very strong electric field is generated, abnormally excessive discharge is generated due to this very strong electric field, and white spot images are formed.

Next, the “ejection” phenomenon in which a contaminant substance adhered to the surface of the charging member returns to the photosensitive member will be described. When toner adheres to the charging member, charge with the same polarity as the applied bias is gradually applied to the toner from the outer surface, depending on whether the bias applied to the charging member is negative or positive. When a sufficient amount of charge is accumulated on the contaminant substance, an electrostatic force acts in the electric field formed from the surface of the charging member toward a photosensitive member drum and exceeds an attachment force between the surface of the charging member and the contaminant, and the contaminant peels off from the surface and moves toward the photosensitive member, a phenomenon known as “ejection” occurs. That is, when a sufficient amount of charge is accumulated on most contaminants and the ejection phenomenon occurs efficiently, the accumulation of contaminants can be prevented

As described above, the charging member disclosed in Japanese Patent Laid-Open No. 2021-67946 has an elastic layer having a matrix-domain structure and a surface layer to which an electron conducting agent is added. In the matrix-domain structure, the outer peripheral surface of the domain has few unevennesses and is close to a perfect sphere, which makes it difficult to create concentration points for electron transfer between domains, and furthermore, due to the presence of an electron-conductive surface layer, charge with the same polarity as the applied bias can be uniformly applied to the contaminant substance. Charge applied to the contaminant substance is generated near the contact part (hereinafter referred to as a nip part) between the charging member and the drum. As the process speed becomes faster, since the time during which charge can be applied to the contaminant substance becomes shorter, it is necessary to improve the amount of charge that can be supplied per unit time. The inventors speculate that, in the charging member disclosed in Japanese Patent Laid-Open No. 2021-67946, in a higher-speed process, the amount of charge that could be supplied per unit time was insufficient, and thus white spots were formed.

From the above, the inventors recognized that, in order to minimize accumulation of contaminant substances even in a high-speed process and a contaminant-intolerant system such as a cleanerless configuration, it is necessary to improve the amount of charge that can be supplied per unit time. Based on such recognition, the inventors have conducted further investigation and as a result, found that, in an electrophotographic member including a support having a conductive outer surface (substrate), an elastic layer provided on the outer surface side of the support and a surface layer provided on the outer surface (surface opposite to the surface that faces the support) of the elastic layer, when the following requirement (A) is satisfied, even in a high-speed process and a contaminant-intolerant system such as a cleanerless configuration, it is possible to minimize the formation of white spot images for a long period.

### Requirement (A)

The elastic layer includes a matrix containing a first rubber, a plurality of regions B in the matrix, and a plurality of regions C in the matrix, the volume resistivity of the matrix is from 1.0×10⁸ Ω·cm to 1.0×10¹² Ω·cm, the region B contains a second rubber different from the first rubber and an electron conducting agent and has a volume resistivity of 1.0×10⁴ Ω·cm or less, the region C contains a third rubber different from both the first rubber and the second rubber and has a volume resistivity of 1.0×10¹² Ω·cm or more, and in cross-sectional observation of a cross section perpendicular to a longitudinal direction of the electrophotographic member, at least a part of the region B includes a region B1, and the region B1 is a domain dispersed in the matrix, in contact with the surface layer, and is a region where the region C exists directly below. Details will be described below.

### Requirement (A)

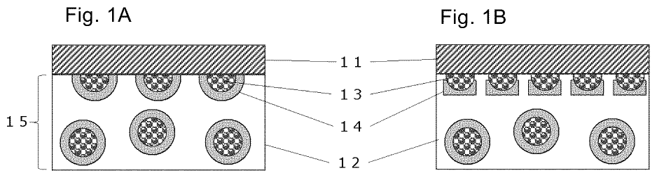

In the requirement (A), in the definition of the region B1, the structure of the elastic layer provided in the interface region between the surface layer and the elastic layer is defined. In the elastic layer provided in the interface region, in the matrix containing the first rubber, the region B containing a second rubber different from the first rubber and an electron conducting agent is dispersed as a domain, and the region C containing a third rubber different from both the first rubber and the second rubber is provided directly below the domain. Such a region is defined as the region B1. An example is shown in FIG. 1A and FIG. 1B.

FIG. 1A and FIG. 1B are cross-sectional schematic views of an elastic layer according to the present disclosure, in which a surface layer 11 is provided on the outer surface of an elastic layer 15.

The elastic layer 15 has a matrix-domain structure including a matrix 12 and a domain, and the domain includes a region B13 and/or a region C14.

Regarding the region B1 which is a domain in contact with the surface layer 11, FIG. 1A shows a structure in which the region C14 surrounds the entire surface of the region B13 that is not in contact with the surface layer 11, but as shown in FIG. 1B, a structure in which the region C14 is provided only directly below the domain in contact with the surface layer may be used.

The volume resistivity of the matrix is 1.0×10⁸ to 1.0×10¹² Ω·cm, preferably 1.0×10⁹ to 1.0×10¹¹ Ω·cm, and more preferably 2.0×10⁹ to 1.0×10¹⁰ Ω·cm.

The volume resistivity of the region B is 1.0×10⁴ Ω·cm or less, preferably 1.0×10¹ to 1.0×10⁴ Ω·cm, more preferably 1.0×10¹ to 1.0×10³ Ω·cm, and still more preferably 2.0×10¹ to 1.0×10² Ω·cm.

The volume resistivity of the region C is 1.0×10¹² Ω·cm or more, preferably 1.0×10¹² to 1.0×10¹⁶ Ω·cm, and more preferably 1.0×10¹³ to 1.0×10¹⁵ Ω·cm.

When the volume resistivities of the regions B and C are within the above range, charge accumulates in the insulating region C directly below the conductive region B1 within the region B, the conductive region B1 enables efficient supply of charge toward the surface layer, “ejection” of contaminant substances can be effectively performed, and thus the accumulation of contaminant substances can be minimized.

In addition, when the matrix has a volume resistivity of 1.0×10⁸ to 1.0×10¹² Ω·cm, rather than being insulating (exceeding 1.0×10¹² Ω·cm), it is possible to inhibit a phenomenon in which the above contaminant substance acquires charge with the opposite polarity to charge that charges the photosensitive member. If the matrix is insulating, when opposite-polarity charge moves from the surface layer toward the core bar (support), charge does not move toward the core bar in the matrix part, and thus the above very strong electric field causes abnormally excessive discharge, and white spot images are easily formed. When the resistivity of the matrix is 1.0×10⁸ to 1.0×10¹² Ω·cm, opposite-polarity charge can be efficiently moved toward the core bar, which not only minimizes accumulation of contaminant substances, but also prevents formation of white spots in the image even if adhesion occurs.

The volume resistivities of the matrix, the region B and the region C can be adjusted by the formulation of a matrix-forming rubber composition (hereinafter referred to as MRC), a core-forming rubber composition and a shell-forming rubber composition, which will be described below. For example, this can be achieved by using a rubber material having a volume resistivity in the above range, or by means of adding an additive as necessary to a rubber material having a high volume resistivity so that the volume resistivity is controlled to be within the above range.

The method of measuring a volume resistivity will be described below.

In addition, the thickness of the region C provided directly below the region B1 is preferably 0.30 μm or less, more preferably 0.01 to 0.30 μm, and still more preferably 0.15 to 0.25 μm.

When the thickness of the region C directly below the region B1 is within the above range, charge effectively accumulates in the region C, charge can be efficiently supplied to the surface layer, and thus the contaminant ejection performance can be improved.

The thickness of the region C directly below the region B1 can be controlled by the addition amount of the third rubber constituting the region C and the compatibility of the third rubber with the first rubber and the second rubber.

Within the region B in the domain, the proportion (amount %) of the region B1 directly below which the region C is provided is preferably 50 to 100%, more preferably 55 to 90%, and still more preferably 60 to 80%.

Within the region B in the domain, when the proportion of the region B1 directly below which the region C is provided is within the above range, charge can be effectively supplied to the entire surface layer, and sufficient contaminant ejection can be performed.

### Conductivity of Surface Layer

The electrophotographic member has a surface layer provided on the outer surface of the conductive layer. If there is no surface layer, the contact area between the toner and the elastic layer is very small, and if the contact part is the matrix part of the elastic layer, charge application to contaminant substances may be insufficient.

In addition, the surface layer preferably contains an electron conducting agent. When the surface layer contains an electron conducting agent, the environmental dependency is low, it is easy to obtain sufficient conductivity in a low temperature and low humidity environment in which excessive discharge due to contaminant substances is generally likely to be generated, and sufficient charge can be applied to contaminant substances in a short time in a high-speed process because charge response is fast.

In addition, in the surface layer, the electron conducting agent is preferably dispersed. When the surface layer in which the electron conducting agent is dispersed is provided, charge can be more sufficiently applied to contaminant substances.

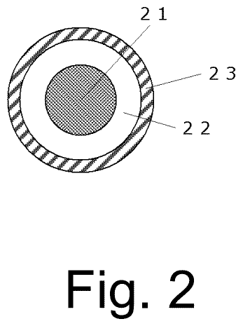

The electrophotographic member according to the present disclosure will be described using a conductive roller as an example with reference to FIG. 2. FIG. 2 is a cross-sectional view showing the configuration of a cross section perpendicular to the longitudinal direction, which is the axial direction, of the conductive roller. The conductive roller has a columnar substrate (support) 21 having a conductive surface, an elastic layer 22 formed on the outer peripheral surface side, that is, the outer surface side, of the substrate 21, and additionally a surface layer 23 in contact with the surface (the outer surface) of the elastic layer 22 opposite to the surface that faces the substrate 21.

### Substrate (Support)

As the material constituting the substrate, those known in the field of conductive members for electrophotography and those appropriately selected from materials that can be used as conductive members can be used. Examples thereof include aluminum, stainless steel, conductive synthetic resins, and metals and alloys such as iron and copper alloys.

In addition, the substrate may be subjected to an oxidation treatment or a plating treatment with chromium, nickel or the like. As the type of plating, either electroplating or electroless plating can be used. In consideration of dimensional stability, electroless plating is preferable. Examples of types of electroless plating used here include nickel plating, copper plating, gold plating, and various other alloy platings.

The plating thickness is preferably 0.05 μm or more, and in consideration of a balance between the operation efficiency and rust prevention ability, the plating thickness is preferably from 0.10 μm to 30.00 μm. The columnar shape of the substrate 21 may be a solid columnar shape or a hollow columnar shape (cylindrical shape). In addition, the outer diameter of the substrate is preferably in a range from 3 mm to 10 mm.

In addition, as necessary, partial processing may be performed for mounting in an electrophotographic apparatus. If there is no medium-resistance layer or insulating layer between the substrate and the elastic layer, it becomes easier to quickly supply charge after consumption of charge due to discharge. Therefore, preferably, the elastic layer is provided directly on the substrate or the elastic layer is provided on the outer periphery (the outer surface side) of the substrate with only an intermediate layer composed of a thin conductive resin layer such as a primer therebetween.

As the primer, a known one selected according to the elastic-layer-forming rubber material and the material of the substrate can be used. Examples of materials of the primer include a thermosetting resin and a thermoplastic resin, and specifically, known materials such as a phenolic resin, a urethane resin, an acrylic resin, a polyester resin, a polyether resin, and an epoxy resin can be used.

### Elastic Layer

The elastic layer includes a first phase including at least a first rubber (for example, a cross-linked product of the first rubber), a second phase including a second rubber (for example, a cross-linked product of the second rubber) different from the first rubber and an electron conducting agent, and a third phase including a third rubber (for example, a cross-linked product of the third rubber) different from both the first rubber and the second rubber. The elastic layer has a matrix-domain structure in which a domain including a second phase and a third phase is dispersed in a matrix including a first phase, and the domain preferably has a core-shell structure in which a core part including a second phase is surrounded by a shell part including a third phase.

### Matrix

The matrix contains a first rubber. The matrix contains, for example, a cross-linked product of the first rubber. The first rubber is a component that forms the matrix in an elastic-layer-forming rubber mixture. In addition, as the first rubber, one that can undergo phase separation from the second rubber described below and form a matrix-domain structure is used. The cross-linked product of the rubber determines the mechanical strength of the elastic layer. Therefore, the first rubber is preferably one that, after crosslinking, provides the elastic layer with the strength required for a conductive member for electrophotography.

### First Rubber

As the first rubber, for example, at least one rubber selected from the group consisting of natural rubber, butadiene rubber, butyl rubber, acrylonitrile butadiene rubber, urethane rubber, silicone rubber, fluorine rubber, isoprene rubber, chloroprene rubber, styrene butadiene rubber, ethylene propylene rubber, polynorbornene rubber and hydrin rubber may be used. Among these, at least one rubber selected from the group consisting of acrylonitrile butadiene rubber, chloroprene rubber and hydrin rubber is preferable, and at least one rubber selected from the group consisting of acrylonitrile butadiene rubber and chloroprene rubber is more preferable.

A reinforcing material can be incorporated into the first rubber forming the matrix as long as it does not affect the conductivity. Examples of reinforcing materials include reinforcing carbon black with low conductivity. Specific examples of reinforcing carbon black include FEF, GPF, SRF, and MT carbon.

In addition, to the first rubber, as necessary, a filler such as calcium carbonate, a processing aid, a vulcanization aid, a vulcanization accelerator, a vulcanization acceleration aid, a vulcanization retarder, an antioxidant, a softener, a dispersing agent, and a colorant may be added.

### Domain

The domain may have either or both of a region B containing a second rubber and an electron conducting agent and a region C containing a third rubber. The third rubber is preferably insulating.

Preferably, the domain including the region B and/or the region C is dispersed in the matrix, and at least a part of the domain is a domain A having a structure in which the region B is surrounded by the region C. That is, preferably, the domain A includes the region B (condition 1) and has a core-shell structure in which a core part including the conductive region B is surrounded by a shell including the insulating region C (condition 2).

The matrix domain structure of the elastic layer is confirmed by cross-sectional observation of the elastic layer using a scanning electron microscope (SEM) as described below.

In the cross-sectional observation, the proportion of the domain A in the domains is preferably 50 amount % or more. 70 amount % or more is more preferable.

When the proportion of the domain A in the domains is 50 amount % or more, it becomes easier to achieve both of the following (i) and (ii).

(i) minimizing excessive discharge by moving charge of contaminants toward the core bar.

(ii) minimizing undesired charge movement in the matrix while charge moves from the conductive support toward the surface layer through the domains in the elastic layer.

As described above, (i) can be achieved when the volume resistivity of the matrix is from 1.0×10⁸ Ω·cm to 1.0×10¹² Ω·cm. In this case, unintended charge movement occurs in the matrix with only a general conductive domain. However, since the core part including the conductive region B is surrounded by the shell part including the insulating region C, the shell part makes it easier to minimize unintended movement of charge into the matrix, and charge easily accumulates in the domain. Therefore, even if the volume resistivity of the matrix is from 1.0×10⁸ Ω·cm to 1.0×10¹² Ω·cm, it is easy to appropriately transfer charge between the conductive core parts in the domain and it is easy to efficiently transport charge from the conductive support toward the surface layer.

In addition, in the cross-sectional observation, it is more preferable that the domain satisfy the following conditions (3) to (5).

Condition (3): The proportion of the cross-sectional area of the electron conducting agent contained in the region B with respect to the cross-sectional area of the region B is 20.0 area % or more.
Condition (4): When the perimeter of the region B in the domain A is S1 and the enveloped perimeter is S2, S1 and S2 satisfy the following Formula (1):

$$1. 00 \leq S 1 / S 2 \leq 1 \text{.10} \qquad ( 1 )$$

Condition (5): The arithmetic mean value Db of the distances between the regions B in the domain A is 0.20 to 2.00 μm.

When the condition (3) is satisfied, the resistivity of the region B in the domain can be stably maintained at 1.0×10⁴ Ω·cm or less. The proportion of the cross-sectional area of the electron conducting agent contained in the region B with respect to the cross-sectional area of the region B is more preferably 20.0 to 40.0 area %, and still more preferably 25.0 to 30.0 area %.

The proportion of the cross-sectional area of the electron conducting agent contained in the region B with respect to the cross-sectional area of the region B can be controlled, for example, by the amount of the electron conducting agent added to the core-forming rubber composition.

The condition (4) indicates that the conductive region B in the domain A has a shape close to a spherical shape. Thereby, movement of charge in the elastic layer from the conductive support to the surface layer interface becomes uniform. This is because, when the domains have irregular shapes and have unevennesses, charge transfer between the domains tends to be concentrated in the protruded portion of the domains, and when the domains have a shape close to a spherical shape, concentration points for charge transfer are reduced.

It is more preferable to satisfy 1.00≤S1/S2≤1.07.

The value of S1/S2 can be increased by increasing the difference in viscosity between the matrix and the domain, and can be reduced by reducing the difference in viscosity between the matrix and the domain.

The condition (5) indicates that the distance between the conductive regions B contained in the domain is the range of distance that charge can move.

The Db is more preferably 0.30 to 1.00 μm and still more preferably 0.40 to 0.70 μm.

When the conditions (3) to (5) are satisfied, the domain dispersed in the matrix enables charge to be effectively supplied to the surface of the elastic layer.

### Second Rubber

As the second rubber, for example, at least one rubber selected from the group consisting of natural rubber, butadiene rubber, butyl rubber, acrylonitrile butadiene rubber, urethane rubber, silicone rubber, fluorine rubber, isoprene rubber, chloroprene rubber, styrene butadiene rubber, ethylene propylene rubber, ethylene propylene diene rubber and polynorbornene rubber can be used. Among these, in order to increase the proportion of the domain A in the domains, at least one rubber selected from the group consisting of butadiene rubber, butyl rubber, isoprene rubber and ethylene propylene diene rubber is preferable.

Here, the second rubber is a rubber different from the first rubber.

### Electron Conducting Agent

The electron conducting agent is, for example, a conductive particle. Examples of conductive particles include particles of electron conducting agents, for example, carbon materials such as conductive carbon black and graphite, conductive oxides such as titanium oxide and tin oxide, metals such as Cu and Ag, and particles made conductive by coating their surfaces with a conductive oxide or metal. Two or more types of these conductive particles mixed in appropriate amounts may be used.

In order to obtain a domain in which conductive particles are filled at a high density, it is preferable to use conductive carbon black as the conductive particles. That is, the electron conducting agent preferably contains carbon black. Carbon black is, for example, preferably at least one selected from the group consisting of gas furnace black, oil furnace black, thermal black, lamp black, acetylene black and ketjen black.

Among these, carbon black having a DBP absorption amount from 40 cm³/100 g to 80 cm³/100 g can be particularly preferably used. The DBP absorption amount (cm³/100 g) is the volume of dibutyl phthalate (DBP) that can be adsorbed by 100 g of carbon black, and is measured according to Japanese Industrial Standards (JIS) K6217-4:2017 (Carbon black for rubber-Fundamental characteristics: Method of determining oil absorption amount (including compressed sample)). Generally, carbon black has a cluster-like higher-order structure in which primary particles having an average particle size from 10 nm to 50 nm are aggregated. The cluster-like higher-order structure is called a structure, and its degree is quantified by the DBP absorption amount (cm³/100 g).

Generally, carbon black with a well-developed structure exhibits high reinforcing properties for rubber, is less likely to be incorporated into rubber, and exhibits a very high shear torque during kneading. Therefore, it is difficult to increase the filling amount in the domain.

On the other hand, conductive carbon black having a DBP absorption amount within the above range has an underdeveloped structure, resulting in less aggregation of carbon black and favorable dispersibility in rubber. Therefore, the filling amount in the domain can be increased, and as a result, it is easier to obtain the domain whose shape is closer to a sphere.

In addition, carbon black with a well-developed structure tends to aggregate, and aggregates are likely to form lumps having large uneven structures. On the other hand, conductive carbon black having a DBP absorption amount within the above range is preferable because it is less likely to form aggregates. The content of conductive particles such as conductive carbon black with respect to 100 parts by mass of the second rubber contained in the domain is preferably from 20 parts by mass to 150 parts by mass. The content is more preferably from 50 parts by mass to 100 parts by mass.

### Third Rubber

As the third rubber, for example, at least one rubber selected from the group consisting of natural rubber, butadiene rubber, butyl rubber, acrylonitrile butadiene rubber, urethane rubber, silicone rubber, fluorine rubber, isoprene rubber, chloroprene rubber, styrene butadiene rubber, ethylene propylene rubber, ethylene propylene diene rubber and polynorbornene rubber may be used. Among these, at least one rubber selected from the group consisting of butadiene rubber, isoprene rubber, styrene butadiene rubber and ethylene propylene diene rubber is preferable.

Here, the third rubber is a rubber different from both the first rubber and the second rubber.

### Method of Forming Elastic Layer

An elastic layer of an electrophotographic member (conductive member) can be formed, for example, by a method including the following steps (I) to (IV).
Step (I): a step of preparing a core-forming rubber composition containing an electron conducting agent and a second rubber (hereinafter referred to as “CMB”).
Step (II): a step of preparing a matrix- and shell-forming rubber composition containing a first rubber and a third rubber (hereinafter referred to as “MSC”).
Step (III): a step of kneading the CMB and the MSC to prepare an elastic-layer-forming rubber composition having a matrix domain structure in which the domain has a core-shell structure.
Step (IV): a step of forming a layer of the elastic-layer-forming rubber composition on a support directly or with another layer therebetween, and curing the layer of the rubber composition to form an elastic layer.

In the MSC, the mixing ratio of the first rubber to the third rubber based on the mass is preferably 90:10 to 60:40, and more preferably 85:15 to 75:25.

The mixing ratio of the CMB to the MSC based on the mass is preferably 10:90 to 40:60, and more preferably 20:80 to 30:70.

Within this range, it is possible to achieve both the effect of efficiently supplying charge to the above surface layer and the effect of smoothly moving opposite-polarity charge from contaminant substances to the conductive support.

The elastic-layer-forming rubber composition may contain, as necessary, known additives such as a vulcanizing agent and a vulcanization accelerator. The elastic layer is, for example, a cross-linked product (vulcanized product) of the elastic-layer-forming rubber composition.

As a method of adjusting the arithmetic mean value Db of the distance between the regions B in the domain to be within the above range of 0.20 to 2.00 μm, it is effective to control the following (a) to (d).
(a) The difference in interfacial tension σ between the CMB and the MSC.
(b) The ratio (ηm/ηd) of the viscosity (ηm) of the MSC to the viscosity (ηd) of the CMB.
(c) The shear rate (γ) during kneading of the CMB and the MSC and the energy content during shearing (EDK) in the step (III).
(d) The volume fraction of the CMB relative to the MSC in the step (III).

### (a) Difference in Interfacial Tension Between CMB and MSC

Generally, when two or more incompatible rubbers are mixed, phase separation occurs. This is because, since the interaction between the same polymers is stronger than the interaction between different polymers, the same polymers aggregate with each other, free energy is reduced and stabilization is achieved.

Since the interface of the phase-separated structure comes into contact with different polymers, it has higher free energy than the interior which is stabilized by the interaction between the same molecules. As a result, in order to reduce the free energy of the interface, an interfacial tension is generated so that the area in contact with the different polymers is reduced. When this interfacial tension is small, the different polymers tend to be mixed more uniformly in order to increase entropy. A uniformly mixed state refers to a dissolved state, and the SP value (solubility parameter), which is an indicator of solubility, tends to correlate with interfacial tension. That is, the difference in interfacial tension between the CMB and the MSC is thought to correlate with the difference in SP value of the rubbers that the compositions contain.

In addition, it is known that, as the dispersion state, when three or more incompatible rubber materials are mixed, various dispersion states are exhibited depending on the SP values of the constituent rubber materials.

When an elastic layer having a matrix-domain structure in which the domain has a core-shell structure is formed according to the present disclosure, it is preferable to select a rubber material such that the SP value of the third rubber material forming the shell is intermediate between the SP values of the first and second rubber materials forming the matrix and the core, and it is preferable that the SP value of the third rubber material forming the shell be smaller than the SP value of the first rubber material forming the matrix, and the SP value of the third rubber material forming the shell be larger than the SP value of the second rubber material forming the core. Rubbers with similar SP values have high affinity for each other. Therefore, when the SP value of the rubber material forming the matrix, the SP value of the rubber material forming the shell, and the SP value of the rubber material forming the core have the above relationship, the domains are more likely to have a core-shell structure, and the proportion of the domain A can be increased.

Here, when the SP values of the rubber materials have the above relationship, it is possible to form the region B1 which is in contact with the surface layer and directly below which the region C is provided. The reason for this will be described using, as an example, a case in which extrusion molding is performed using a crosshead when the elastic-layer-forming rubber composition in the step (IV) is formed around the support. In the rubber composition flowing inside the crosshead, the flow rate of rubber on the outer periphery that comes into contact with the inner wall of the crosshead, that is, on the surface side of the elastic layer, becomes slower. Therefore, in the elastic-layer-forming rubber composition, the domain forming material CMB, which is highly filled with an electron conducting agent, does not flow easily and tends to transfer toward the surface of the elastic layer where the flow rate is slow.

When the SP value of the second rubber in the domain forming material is closer to the SP value of the third rubber than to the SP value of the first rubber forming the matrix, the third rubber has higher compatibility with the domain, it is easier to form a structure in which the domain and the third rubber are linked, as shown in FIG. 1B, and it is possible to form the region B1, where the region C containing the third rubber is provided directly below the domain. The surface of the elastic layer may be removed and re-shaped in a post-step such as polishing. Even in this case, when the domain A having a core-shell structure surrounded by the third rubber inside the elastic layer is exposed on the surface of the elastic layer when the outermost surface is removed, it is possible to form the region B1, where the region C containing the third rubber is provided directly below the domain as shown in FIG. 1A.

In addition, the proportion of the region B1 can be increased by increasing the addition proportion of the third rubber in the MSC.

The difference in absolute values of the solubility parameters of the rubber materials is preferably 0.4 to 5.0 (J/cm³)^{0.5}, and particularly preferably 0.4 to 2.2 (J/cm³)^{0.5}. Within this range, a stable phase-separated structure can be formed, and the domain diameter D can be reduced.

The thickness of the elastic layer is not particularly limited as long as desired functions and effects of the electrophotographic member are obtained. The thickness of the elastic layer is preferably from 1.0 mm to 4.5 mm.

### Method of Measuring SP Value

The SP value can be calculated accurately by creating a calibration curve obtained using materials with known SP values. For the known SP values, catalog values from material manufacturers can be used. For example, the SP values of the NBR and SBR are primarily determined by the contents of acrylonitrile and styrene, independent of their molecular weight.

Therefore, the content of acrylonitrile or styrene in the rubber constituting the matrix and the domain is analyzed using an analysis technique such as pyrolysis-gas chromatography (Py-GC) and solid-state NMR. Thereby, the SP value can be calculated from a calibration curve obtained from the materials with known SP values.

In addition, the SP value of isoprene rubber is determined by its isomeric structure such as 1,2-polyisoprene, 1,3-polyisoprene, 3,4-polyisoprene, cis-1,4-polyisoprene, and trans-1,4-polyisoprene. Therefore, in the same manner as in the SBR and NBR, the isomer content is analyzed through Py-GC, solid-state NMR or the like, and the SP value can be calculated from materials with known SP values.

The SP values of materials with known SP values are determined using the Hansen sphere method.

### (b) Viscosity Ratio of CMB to MSC

As the viscosity ratio (ηd/ηm) of the CMB to the MSC is closer to 1, the domain diameter can be smaller. Specifically, the viscosity ratio is preferably from 1.0 to 2.0. The viscosity ratio of the CMB to the MSC can be adjusted by selecting the Mooney viscosity of the raw material rubber used in the CMB and the MSC or by the type and amount of fillers added.

In addition, it is also possible to add a plasticizer such as paraffin oil as long as it does not interfere with the formation of a phase-separated structure. In addition, the viscosity ratio can be adjusted by adjusting the temperature during kneading.

Here, the viscosity of the core-forming rubber composition and the matrix- and shell-forming rubber composition can be obtained by measuring the Mooney viscosity ML₍₁₊₄₎ at the rubber temperature during kneading based on JIS K 6300-1:2013.

### (c) Shear Rate During Kneading of MSC and CMB and Energy Content During Shearing

As the shear rate during kneading of the MSC and the CMB is faster and the energy content during shearing is larger, the distance between the domains can be reduced.

The shear rate can be increased by increasing the inner diameter of a stirring member such as a blade and a screw of a kneading machine, reducing the gap between the end surface of the stirring member and the inner wall of the kneading machine, or increasing the rotation speed. In addition, an increase in the energy during shearing can be achieved by increasing the rotation speed of the stirring member and by increasing the viscosities of the second rubber in the CMB and the first rubber and the third rubber in the MSC.

### (d) Volume Fraction of CMB Relative to MSC in Step (III)

The volume fraction of the CMB relative to the MSC correlates with the probability of collision and coalescence between the core-forming rubber composition and the matrix- and shell-forming rubber composition. Specifically, when the volume fraction of the core-forming rubber composition relative to the matrix- and shell-forming rubber composition is reduced, the probability of collision and coalescence between the core-forming rubber composition and the matrix- and shell-forming rubber composition decreases. That is, the distance between cores can be reduced when the volume fraction of the core in the matrix is reduced within a range in which required conductivity is obtained.

### Surface Layer

The surface layer preferably contains an electron conducting agent. When the surface layer containing an electron conducting agent that is dispersed in the binder resin is formed, the dispersion proceeds sufficiently, which is also preferable in terms of physical durability of the surface layer. That is, the surface layer preferably contains a binder resin and an electron conducting agent dispersed in the binder resin. In addition, more preferably, the surface layer contains a binder resin and an electron conducting agent dispersed in the binder resin, the surface of the surface layer has a protruded portion derived from an exposed part of the electron conducting agent, and the universal hardness at a position with a depth of 1 μm from the surface of the surface layer is from 1.0 N/mm² to 7.0 N/mm². The protruded portion and the universal hardness will be described below.

The surface layer may contain, as necessary, coarse particles, a surface release agent and the like.

### Electron Conducting Agent of Surface Layer

Examples of electron conducting agents contained in the surface layer include metal oxide-based conductive particles such as conductive carbon black, titanium oxide, tin oxide, and zinc oxide, and conductive particles such as metal-based conductive particles of aluminum, iron, copper, and silver. That is, the electron conducting agent is preferably a conductive particle. These conductive particles can be used alone or two or more thereof can be used in combination.

In addition, as the conductive particles, composite particles in which silica particles are coated with conductive particles can also be used. The electron conducting agent used in the surface layer preferably contains carbon black. Since carbon black has a low specific gravity and has high conductivity, it is possible to secure sufficient conductivity for the surface layer with a small amount of carbon black added to the binder resin. In the present disclosure, since it is preferable to maintain the hardness of the surface layer at a low level, carbon black suitable for small-amount addition is suitable.

The content of the electron conducting agent with respect to 100 parts by mass of the binder resin is preferably 10 to 40 parts by mass, and more preferably 15 to 30 parts by mass.

### Binder Resin

As the binder resin, known binder resins can be used. Examples thereof include various synthetic resins, natural rubber or vulcanized natural rubber, synthetic rubber and other rubbers. As the binder resin, a fluorine resin, a polyamide resin, an acrylic resin, a polyurethane resin, a silicone resin, a butyral resin, a styrene-ethylene/butylene-olefin copolymer, an olefin-ethylene/butylene-olefin copolymer or the like can be used.

The binder resins can be used alone or two or more thereof can be used in combination.

The binder resin preferably includes a polyurethane resin. The polyurethane resin is preferably selected from the group consisting of a polyester-based polyurethane obtained by copolymerizing a polyester polyol and a polyisocyanate, a polycarbonate-based polyurethane obtained by copolymerizing a polycarbonate polyol and a polyisocyanate, and a polyurethane obtained by copolymerizing ε-caprolactone modified polyol and a polyisocyanate.

Among these, the binder resin is particularly preferably a resin having a polycarbonate structure in order to achieve both flexibility according to a decrease in the universal hardness of the surface layer and high resistance of the surface layer. Since the polycarbonate structure has low polarity, the binder resin itself can maintain a high volume resistivity. Specifically, a polycarbonate-based polyurethane obtained by copolymerizing a polycarbonate polyol and a polyisocyanate is preferable.

Examples of polycarbonate polyols include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random/block copolymers thereof.

The polyisocyanate may be selected from generally used known ones, and examples thereof include the following: toluene diisocyanate (TDI), diphenylmethane diisocyanate (MDI), polymeric diphenylmethane polyisocyanate, hydrogenated MDI, xylylene diisocyanate (XDI), hexamethylene diisocyanate (HDI), and isophorone diisocyanate (IPDI). Among these, aromatic isocyanates such as toluene diisocyanate (TDI), diphenylmethane diisocyanate (MDI), and polymeric diphenylmethane polyisocyanate are more preferably used.

### Universal Hardness of Surface Layer

In order to minimize the generation of contaminant substances, it is effective to prevent the toner from cracking and deforming. For this purpose, it is preferable that the surface layer be flexible. As an indicator of the hardness of the electrophotographic member, “Universal hardness (at t=1 μm position)” which is a universal hardness at a position with a depth of 1 μm from the outer surface of the surface layer, is preferably 1.0 to 7.0 N/mm², and more preferably 2.0 to 5.0 N/mm².

The universal hardness of the surface layer can be appropriately controlled by the resin composition forming the surface layer and additives.

Since the size of external additives and toner is on the order of submicrons to several microns, it is preferable to control the hardness of the surface layer in the immediate vicinity of the outer surface, which is the surface that comes into contact with the external additives and toner. Specifically, if the universal hardness of the surface is set to 1.0 N/mm² or more when an indenter is pressed 1 μm into the outer surface of the surface layer, it becomes easier to minimize the occurrence of image density non-uniformity resulting from deformation of the charging roller that occurs when the electrophotographic member (charging roller) is brought into contact with the electrophotographic photoreceptor in a stationary state for a long period of time. In addition, when the universal hardness is set to 7.0 N/mm² or less, the occurrence of deformation and cracking of the toner can be minimized, and thus it is possible to more reliably minimize the absolute amount of irregularly shaped toner and finely powdered toner remaining on the photosensitive member.

In addition, when the universal hardness is set to 5.0 N/mm² or less, since the surface layer deforms in response to the contaminant substance, the number of contact points between the protruded portion resulting from the electron conducting agent exposed on the surface of the surface layer and the contaminant substance increases, and the efficiency of injection of electrons from the protruded portion into the contaminant substance is improved. The universal hardness (t=1 μm position) can be controlled by the molecular weight of the polyol component and the ratio of the polyol component and the polyisocyanate component.

Here, the universal hardness of the surface of the surface layer as a charging roller is measured, for example, using a universal hardness tester (product name: Fischerscope HM2000XYp, commercially available from Fischer Instruments K.K.). More specific procedures will be described below.

### Protruded Portion of Surface Layer Derived From Electron Conducting Agent

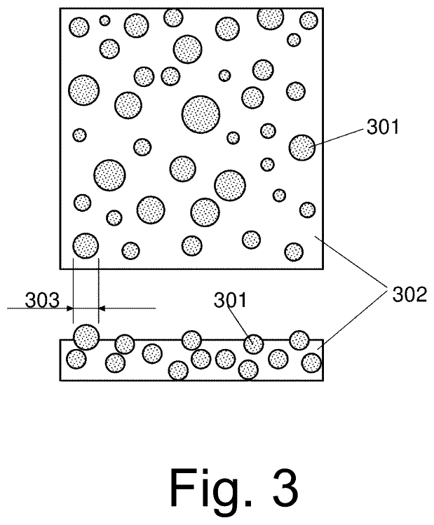

In order to inject charge into the contaminant substance, it is preferable to provide the protruded portion derived from the exposed part of the electron conducting agent (conductive particle) on the surface of the surface layer. The size of the protruded portion derived from the exposed part of the electron conducting agent is preferably from 5.0 nm to 100.0 nm. When the size is set to 5.0 nm or more, the protruded portion can function as a starting point for more efficiently injecting charge into the contaminant substance. In addition, when the size is set to 100.0 nm or less, it is possible to minimize excessive charge injection into the photosensitive member. Here, as shown in FIG. 3, the size of the protruded portion is the average value (number average particle diameter) of the particle diameter 303 of an electron conducting agent 301 in the part exposed from a binder resin 302. As a method of measuring the size of the protruded portion, an image of a 2 μm square region is captured using an SEM, the particle diameters of 20 particles randomly selected in the obtained image are measured, and an arithmetic mean particle diameter is determined.

In addition, it is preferable that the outer surface of the surface layer have a protruded portion derived from the exposed part of the electron conducting agent. In order to inject charge into the contaminant substance using the protruded portion derived from the electron conducting agent, it is effective to control the number of protruded portions. The number of protruded portions derived from the exposed part of the electron conducting agent is preferably 50 to 500 and more preferably 200 to 400 in a region of 2.0 μm length and 2.0 μm width (4.0 μm² region). When the number of protruded portions is 50 or more, it is possible to secure the number of protruded portions serving as starting points for injecting charge into the contaminant substance. In addition, when the number of protruded portions is 500 or less, it is possible to minimize injection of charge into the photosensitive member. The number of protruded portions can be calculated by capturing an image of a 2 μm square region using a scanning electron microscope (SEM), and calculating the number of conductive points in the binary image.

Next, a method of exposing an electron conducting agent (conductive particle) on the surface of the surface layer will be described. When a surface layer is formed on the elastic layer of the conductive member by a dipping coating method, a skin layer is always formed on the outermost surface of the surface layer. Therefore, in order to expose the electron conducting agent on the outer surface of the surface layer and generate a protruded portion on the outer surface of the surface layer due to the exposed part, it is effective to remove the skin layer on the outermost surface.

For example, by performing an ultraviolet treatment, a polishing method, an electrolytic polishing method, a chemical polishing method, an ion milling method or the like, the surface skin layer formed of a binder resin is removed, the electron conducting agent is exposed on the outer surface of the surface layer, and a protruded portion is easily formed. In the present disclosure, because the surface layer has a low hardness, even if the ultraviolet treatment is performed, the skin layer can be sufficiently removed, and the electron conducting agent can be exposed on the surface of the surface layer. The ultraviolet treatment is preferable because, compared to the polishing method and the like, it can expose the electron conducting agent on the surface of the surface layer while minimizing damage to the surface layer.

The exposed state of the electron conducting agent can be confirmed using an atomic force microscope (AFM). A height image is acquired in an AFM tapping mode. In this case, the part derived from the exposed part of the electron conducting agent is observed as a protruded portion. When a height image is acquired in the presence of the skin layer after dip coating, the protruded portion is not observed. In addition, a phase image is acquired in the AFM tapping mode. In this case, since the phase shift of the electron conducting agent is small and there is a difference in hardness between the binder resin and the electron conducting agent, an image with a very large light- and dark-contrast difference is obtained. When a phase image is acquired in the presence of the skin layer after dip coating, an image with a very small phase difference and a low contrast difference is acquired.

### Coarse Particles

The surface layer may contain coarse particles as long as the effects of the present disclosure are not impaired. Examples of coarse particles include the following: organic insulating particles such as an acrylic resin, a polycarbonate resin, a styrene resin, a urethane resin, a fluorine resin and a silicone resin; inorganic insulating particles such as titanium oxide, silica, alumina, magnesium oxide, strontium titanate, barium titanate, barium sulfate, calcium carbonate, mica, zeolite and bentonite.

In the present disclosure, it is preferable to use flexible organic insulating particles as coarse particles in order to increase the opportunity of contact with contaminant substances such as external additives and toner by allowing the surface layer to deform. These particles may be used alone or two or more thereof may be used in combination. The number average particle diameter of the coarse particles is not particularly limited, and is, for example, from 3.0 μm to 30.0 μm.

### Ion Conducting Agent

The surface layer may contain an ion conducting agent as long as the effects of the present disclosure are not impaired. In order to transport charge supplied to the adhered contaminant from the elastic layer, it is preferable that the surface layer contain an electron conducting agent with favorable response, but an ion conducting agent with relatively low (slow) response may be added as an auxiliary agent. Thereby, at a certain moment, the charge that can be supplied to contaminants on the surface is the sum of the charge instantly transported from the elastic layer by the electron conducting agent and the charge that leaves the elastic layer slightly earlier and is transported with a delay by the ion conducting agent. Therefore, when the electron conducting agent mainly transports charge, the likelihood of insufficient charge supply is further reduced.

The ion conducting agent is not particularly limited as long as it is an ion conducting agent that exhibits ion conductivity, and examples thereof include the following: inorganic ionic substances such as lithium perchlorate, sodium perchlorate, and calcium perchlorate; quaternary ammonium salts such as lauryltrimethylammonium chloride, stearyltrimethylammonium chloride, and tetrabutylammonium perchlorate; and organic acid inorganic salts such as lithium trifluoromethanesulfonate and potassium perfluorobutanesulfonate. These can be used alone or two or more thereof can be used in combination.

Among ion conducting agents, when the ion conducting agent has a functional group that easily forms a bond with the material constituting the surface layer, it is preferable because the ion conducting agent is fixed within the surface layer and thus it is easier to maintain properties for a long period. For example, when the surface layer has a urethane bond, the ion conducting agent has an OH group. More preferably, the ion conducting agent has an imidazolium structure in its structure. This is because it is easy to delocalize charge on the imidazolium ring and it is less likely to cause charge localization within the structure and thus uniform charge movement within the surface layer and more uniform charge supply to contaminants can be expected.

Since the ion conducting agent is used in an auxiliary role to the electron conducting agent, its content is less than that of the electron conducting agent constituting the surface layer, and is preferably from 0.01 parts by mass to 5.0 parts by mass with respect to 100 parts by mass of the binder resin. The content is more preferably from 0.01 parts by mass to 2.0 parts by mass.

### Other Additives

As necessary, other additives may be added to the surface layer, provided that the effects of the present disclosure are not impaired. As additives, a chain extender, a crosslinking agent, a pigment, a silicone additive, an amine such as a catalyst, a tin complex and the like may be added. When a silicone additive is added to the surface layer, the resistance of the surface layer increases, slipperiness is imparted to the surface layer, injection of charge into the photosensitive member is minimized, and the wear resistance of the surface layer is improved. Therefore, it is particularly preferable to add a silicone additive.

### Layer Thickness of Surface Layer

The surface layer preferably has a thickness of 0.1 to 100 μm. The thickness of the surface layer is more preferably 1 to 50 μm, still more preferably 5 to 30 μm, and yet more preferably 10 to 30 μm. Here, the thickness of the surface layer can be measured by cutting out a cross section of a roller with a sharp blade and performing observation under an optical microscope or an electron microscope.

### Volume Resistivity of Surface Layer

When an electrophotographic member (conductive member) is used as a charging roller, the volume resistivity of the surface layer of the charging roller is preferably 1.0×10¹⁰ to 1.0×10¹⁶ Ω·cm. More preferably, 5.0×10¹⁰ to 1.0×10¹⁶ Ω·cm. When the electrophotographic member is used as a charging roller, it is preferable to set the volume resistivity of the surface layer to be a large value. When the volume resistivity of the surface layer increases, contaminant substances can more easily return to the photosensitive member, and the amount of the contaminant substances adhering to and accumulating on the charging roller can be further reduced.

The inventors believe that this is because, when a negatively charged contaminant substance comes into direct contact with the surface layer, particularly, with the binder resin where the electron conducting agent (conductive particle) is not exposed on the surface, the negative charge of the contaminant substance moves toward the surface layer of the charging roller, and the negative charge of the contaminant substance may decay. In order to minimize decay of the negative charge of the contaminant substance, it is preferable that the surface layer have high resistance, and for this purpose, the volume resistivity of the surface layer is preferably 1.0×10¹⁰ Ω·cm or more.

In addition, the inventors confirmed that, when the volume resistivity of the surface layer is low, charge is injected from the charging roller into the photosensitive member. This phenomenon becomes significant when the hardness of the surface layer is low and when there is a difference in peripheral velocity between the charging roller and the photosensitive member. During actual image output, since the quantity of injected charge is added to the charge quantity due to discharge, when the quantity of injected charge is large, it may be difficult to maintain a stable surface potential of the photosensitive member. A guideline for the quantity of injected charge for maintaining output at a stable image density is 50 V or less, and to achieve this, the volume resistivity of the surface layer is more preferably 1.0×10¹⁰ Ω·cm or more.

In addition, in order to stabilize discharge with the charging roller, the volume resistivity of the surface layer is preferably 1.0×10¹⁶ Ω·cm or less. The quantity of charge injected from the charging roller into the photosensitive member can be estimated, for example, as follows.

In a high temperature and high humidity environment (a temperature of 30° C. and a relative humidity of 80%) in which the quantity of injected charge increases, the surface potential of the photosensitive member is measured when a voltage is applied to the charging roller (for example, DC-500 V) under conditions in which the charging roller does not discharge. For measurement of the volume resistivity of the surface layer, a measurement value measured using an atomic force microscope (AFM) in a conductivity mode can be used. A sheet is cut out from the surface layer of the charging roller using a manipulator, and metal deposition is performed on one surface of the surface layer. A DC power source is connected to the metal-deposited surface, a voltage is applied, a free end of a cantilever is brought into contact with the other surface of the surface layer, and a current image is obtained through the AFM main body. The current values at 100 randomly selected points on the surface are measured, and the volume resistivity can be calculated from the average current value of the 10 lowest measured current values, the average film thickness, and the contact area of the cantilever.

### Method of Forming Surface Layer

The method of forming a surface layer is not particularly limited, and examples thereof include spraying, immersion (dipping coating method), and roll coating using a coating material obtained by adding a solvent to a raw material. As the method of forming a surface layer, the dipping coating method is simple and has excellent production stability. In addition, after coating, as necessary, an additional treatment such as heating is performed. The method of forming a surface layer preferably includes a step of applying a coating material containing raw materials including a binder resin raw material and an electron conducting agent to the outer surface of an elastic layer and a step of curing the binder resin raw material to form a surface layer.

### Process Cartridge

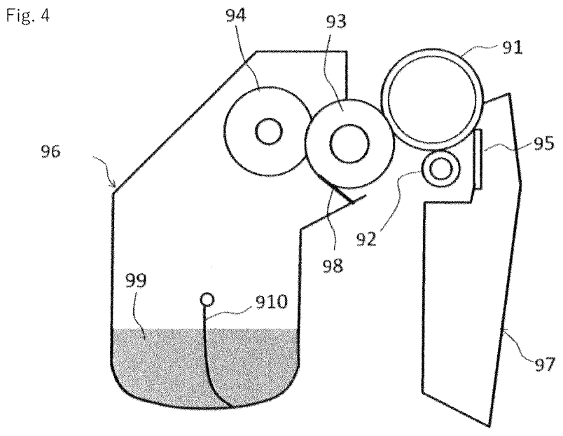

At least one aspect of the present disclosure provides a process cartridge that is detachable from a main body of an electrophotographic image forming apparatus,
wherein the process cartridge includes an electrophotographic photoreceptor and a charging member that is arranged so that it is able to charge the electrophotographic photoreceptor, and the charging member is the electrophotographic member of the present disclosure. FIG. 4 is a schematic cross-sectional view of a process cartridge for electrophotography using an electrophotographic member according to one embodiment of the present disclosure as a charging member (charging roller). The process cartridge is formed by integrating a developing apparatus and a charging apparatus and is configured to be detachable from the main body of the electrophotographic apparatus.

The developing apparatus includes at least a developing roller 93, a toner container 96, and a toner 99 that are integrated, and may include, as necessary, a toner supply roller 94, a developing blade 98, and a stirring blade 910.

The charging apparatus includes at least a photosensitive drum 91 and a charging roller 92 that are integrated, and may include a cleaning blade 95 and a waste toner container 97. A voltage is applied to each of the charging roller 92, the developing roller 93, the toner supply roller 94 and the developing blade 98.

In addition, the electrophotographic member according to the present disclosure can be used as a charging roller, a developing roller, a developing blade and a toner supply roller. The electrophotographic member is preferably a charging member, and the electrophotographic member is more preferably a charging roller.

### Electrophotographic Image Forming Apparatus

At least one aspect of the present disclosure provides an electrophotographic image forming apparatus including an electrophotographic photoreceptor and a charging roller that is arranged so that it is able to charge the electrophotographic photoreceptor, wherein the charging roller is the electrophotographic member of the present disclosure.

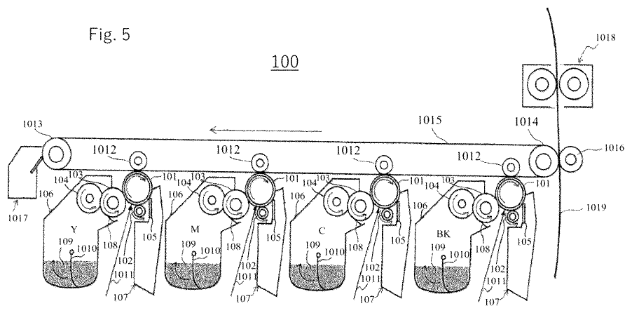

FIG. 5 is a schematic configuration diagram of an electrophotographic image forming apparatus 100 using an electrophotographic member according to one embodiment of the present disclosure as a charging member (charging roller). This apparatus is a color electrophotographic apparatus in which the process cartridge is detachably mounted. In each process cartridge, toners of colors such as black BK, magenta M, yellow Y, and cyan C are used.

A photosensitive drum 101 rotates in the direction of the arrow and is uniformly charged by a charging roller 102 to which a voltage is applied from a charging bias power source, and an electrostatic latent image is formed on its surface by exposure light 1011. On the other hand, a toner 109 stored in a toner container 106 is supplied to a toner supply roller 104 by a stirring blade 1010 and transported onto a developing roller 103. Then, a developing blade 108 arranged in contact with the developing roller 103 allows the toner 109 to be uniformly coated on the surface of the developing roller 103, and allows charge to be applied to the toner 109 through triboelectric charging. The electrostatic latent image is developed by applying the toner 109 transported by the developing roller 103 arranged in contact with the photosensitive drum 101 and visualized as a toner image.

The visualized toner image on the photosensitive drum is transferred by a primary transfer roller 1012 to which a voltage is applied from a primary transfer bias power source onto an intermediate transfer belt 1015 supported and driven by a tension roller 1013 and an intermediate transfer belt driver roller 1014. The toner images of respective colors are sequentially superimposed and a color image is formed on the intermediate transfer belt.

A transfer material 1019 is fed into the apparatus by a paper feed roller, and transported between the intermediate transfer belt 1015 and a secondary transfer roller 1016. A voltage is applied to the secondary transfer roller 1016 from a secondary transfer bias power source, and the secondary transfer roller 1016 transfers the color image on the intermediate transfer belt 1015 to the transfer material 1019. The transfer material 1019 onto which the color image has been transferred is fixed by a fixing unit 1018, and is discharged outside of the apparatus, and the printing operation is completed.

On the other hand, the toner remaining on the photosensitive drum without being transferred is scraped off by a cleaning blade 105 and stored in a waste toner storage container 107, and the cleaned photosensitive drum 101 repeats the above steps. In addition, the toner remaining on the primary transfer belt without being transferred is also scraped off by a cleaning apparatus 1017.

Here, although a color electrophotographic apparatus is shown as an example, in a monochrome electrophotographic apparatus (not shown), the process cartridge uses only black toner. A monochrome image is formed directly onto the transfer material by the process cartridge and the primary transfer roller (without the secondary transfer roller) without using an intermediate transfer belt. Then, the transfer material is fixed by the fixing unit and discharged outside of the apparatus, and thus the printing operation is completed.

### EXAMPLES

The present disclosure will be described below with reference to examples, but the technical scope of the present disclosure is not limited thereto.

Examples and comparative examples will be described below. Electrophotographic members (conductive members) of the examples and the comparative examples were produced using materials shown in Table 1.

TABLE 1

| Material | Material | Material | Product | Manufacturer |
|---|---|---|---|---|
| type | abbreviation | name | name | name |
| Rubber | N230SV | Acrylonitrile | NBR N230SV | ENEOS Materials |
| material | | butadiene rubber (NBR) | | Corporation |
| | T2003 | Styrene butadiene | TUFDENE 2003 | Asahi Kasei |
| | | rubber (SBR) | | Corporation |
| | E505A | Ethylene propylene | Esplene505A | Sumitomo |
| | | diene rubber (EPDM) | | Chemical |
| | BR150B | Polybutadiene | UBEPOL BR150B | UBE Corporation |
| | | rubber (BR) | | |
| | IR2200L | Isoprene | Nipol IR2200L | Nippon Zeon |
| | | rubber (IR) | | Corporation |
| | B31 | Chloroprene | SKYPRENE B31 | Tosoh |
| | | rubber (CR) | | Corporation |
| | Butyl 065 | Butyl rubber | Butyl 065 | ENEOS Materials |
| | | (Butyl) | | Corporation |
| Conducting | #7360SB | Carbon black | TOKABLACK#7360SB | Tokai Carbon |
| agent | #7270SB | Carbon black | TOKABLACK#7270SB | Tokai Carbon |
| | #5500 | Carbon black | TOKABLACK#5500 | Tokai Carbon |
| | Tin oxide | Tin-based oxide | S-2000 | Mitsubishi Materials |
| | | | | Electronic Chemicals |
| Vulcanizing | PMC | Sulfur | SULFAX PMC | Tsurumi Chemical |
| agent | | | | Industry |
| Vulcanization | TBzTD | Tetrabenzylthiuram | Sanceler | Sanshin Chemical |
| accelerator | | disulfide | TBz TD | Industry |
| | TBSI | N-t-Butyl-2- | SANTOCRE - | FLEXSYS |
| | | benzothiazolesulfenamide | TBSI | |
| Vulcanization | Zinc oxide | Zinc oxide | Zinc oxide | Sakai Chemical |
| acceleration aid | | | 2 types | Industry |
| Filler | #30 | Calcium carbonate | Nanox #30 | Maruo Calcium |
| Processing | SZ-2000 | Zinc stearate | SZ-2000 | Sakai Chemical |
| aid | | | | Industry |

### 1. Preparation of Elastic-Layer-Forming Unvulcanized Rubber Composition

### 1-1. Preparation of Region-B-forming Carbon Masterbatch 1 (CMB 1)

Materials of types and formulation amounts shown in Table 2 were mixed using a 6-liter pressure kneader (product name: TD6-15MDX, commercially available from Toshin Inc.) to obtain a region-B-forming carbon masterbatch 1 (CMB 1). The mixing conditions were a filling rate of 70 vol %, a blade rotation speed of 30 rpm, a temperature of 130° C. in the kneader, and 16 minutes.

TABLE 2

| | | Formulation |
|---|---|---|
| | Material name | amount (parts |
| | (abbreviation) | by mass) |
| Second rubber | E505A | 100 |
| Electron | #7360SB | 60 |
| conducting agent | | |
| Vulcanization | Zinc oxide | 5 |
| acceleration aid | | |
| Processing aid | SZ-2000 | 2 |

### 1-2. Preparation of Matrix- and Region-C-Forming Rubber Composition 1 (MSC1)

Materials of types and formulation amounts shown in Table 3 were mixed using a 6-liter pressure kneader (product name: TD6-15MDX, commercially available from Toshin Inc.) to obtain a matrix- and region-C-forming rubber composition 1 (MSC 1). The mixing conditions were a filling rate of 70 vol %, a blade rotation speed of 30 rpm, a temperature of 100° C. in the kneader, and 16 minutes.

TABLE 3

| | | Formulation |
|---|---|---|
| | Material name | amount (parts |
| | (abbreviation) | by mass) |
| First rubber | N230SV | 80 |
| Third rubber | T2003 | 20 |
| Filler | #30 | 40 |
| Vulcanization | Zinc oxide | 5 |
| acceleration aid | | |
| Processing aid | SZ-2000 | 2 |

### 1-3. Preparation of Conductive-Elastic-Layer-Forming Unvulcanized Rubber Composition 1

Materials of types and formulation amounts shown in Table 4 were mixed using an open roller to obtain a conductive-elastic-layer-forming unvulcanized rubber composition 1. As a mixer, an open roller with a roll diameter of 12 inches was used. The mixing conditions were as follows: the front roll rotation speed was 10 rpm, the rear roll rotation speed was 8 rpm, the roll gap was 2 mm, and after performing a total of 20 left-and-right reversals, the roll gap was reduced to 1.0 mm, and 10 thin passes were performed.

TABLE 4

| | | Formulation |
|---|---|---|
| | Material name | amount (parts |
| | (abbreviation) | by mass) |
| Raw material | CMB1 | 26 |
| rubber | | |
| Raw material | MSC1 | 74 |
| rubber | | |
| Vulcanizing | PMC | 3 |
| agent | | |
| Vulcanization | TBzTD | 1 |
| accelerator 1 | | |
| Vulcanization | TBSI | 0.5 |
| accelerator 2 | | |

### 2. Production of Conductive Elastic Roller

### 2-1. Formation of Conductive Elastic Layer

As a support, a core bar with a total length of 252 mm and an outer diameter of 6 mm, made of free-cutting steel with an electroless nickel-plated surface was prepared. This core bar was used as the support, which is a conductive shaft core. Using a roll coater, an adhesive (product name: Metaloc U-20, commercially available from Toyokagaku Kenkyusho Co., Ltd.) was applied over the entire circumference of a 230 mm section of the core bar, excluding 11 mm at each end. In this example, the core bar coated with the adhesive was used as a conductive support.

Next, a die with an inner diameter of 10.5 mm was attached to the tip of a crosshead extruder including a conductive support supply mechanism and an unvulcanized rubber roller discharge mechanism, the temperature of the extruder and the crosshead was adjusted to 100° C., and the transport speed of the conductive support was adjusted to 60 mm/sec. Under these conditions, the conductive-elastic-layer-forming unvulcanized rubber composition 1 was supplied from the extruder, and the outer periphery of the conductive support was coated with the conductive-elastic-layer-forming unvulcanized rubber composition 1 in the crosshead to obtain an unvulcanized rubber roller.

Next, the unvulcanized rubber roller was placed in a hot air vulcanizing oven at 170° C. and heated for 60 minutes to vulcanize the unvulcanized rubber composition, and a vulcanized rubber roller with a conductive elastic layer formed on the outer periphery of the conductive support was obtained. Then, 10 mm was cut off from each end of the elastic layer, and the length of the elastic layer in the longitudinal direction was 232 mm.

### 2-2. Production of Conductive Elastic Roller 1 by Polishing Conductive Elastic Layer

Next, the surface of the elastic layer was polished under the polishing condition described in the following polishing condition 1 to obtain a crown-shaped conductive elastic roller 1 having a diameter of 9.7 mm at the center and a diameter of 9.65 mm at each position 90 mm from the center to both ends.

### Polishing Condition 1

A cylindrical grinding stone having a diameter of 305 mm and a length of 235 mm (commercially available from Teiken Co., Ltd.) was prepared. The type, grain size, bond strength, linker, and structure (abrasive grain percentage) of abrasive grains were as follows.
Abrasive grain material: GC (green silicon carbide), (JIS R 6111-2002)
Grain size of abrasive grain: #80 (an average particle size of 177 μm JIS B 4130)
Bond strength of abrasive grain: HH (JIS R 6210)
Linker: V₄PO (Vitrified)
Structure of abrasive grain (abrasive grain percentage): 23 (abrasive grain content 16% JIS R 6242)

The polishing conditions were as follows: the rotation speed of the grinding stone was 2,100 rpm, the rotation speed of the conductive member was 250 rpm, and in the rough polishing step, the speed of the grinding stone penetrating into the conductive member was 20 mm/sec, and the grinding stone was allowed to penetrate 0.24 mm after it came into contact with the outer peripheral surface of the conductive member. In the fine polishing step, the penetration speed was changed to 0.5 mm/sec, and the grinding stone was allowed to penetrate 0.01 mm. Then, the grinding stone was separated from the conductive member to complete polishing. As the polishing method, an upper-cut method in which the grinding stone and the conductive member rotated in the same rotation direction was used.

### 2-3. Production of Conductive Elastic Rollers 2 to 19

Conductive elastic rollers 2 to 19 were produced in the same manner as in the above “2-1” and “2-2” except that the region-B-forming carbon masterbatch (CMB), the matrix- and region-C-forming rubber composition (MSC), and the surface layer coating solution were changed as shown in Tables 5 to 8.

### 2-4. Production of Conductive Elastic Roller 20

As a support, a core bar with a total length of 252 mm and an outer diameter of 6 mm, made of free-cutting steel with an electroless nickel-plated surface was prepared. This core bar was used as the support, which is a conductive shaft core. Using a roll coater, an adhesive (product name: Metaloc U-20, commercially available from Toyokagaku Kenkyusho Co., Ltd.) was applied over the entire circumference of a 230 mm section of the core bar, excluding 11 mm at each end. In this example, the core bar coated with the adhesive was used as a conductive support.

Next, the conductive-elastic-layer-forming unvulcanized rubber composition 1 was applied to the substrate using a crosshead extruder (commercially available from Mitsuba MFG. Co., Ltd.) to produce a crown-shaped unvulcanized rubber roller. A die with an inner diameter of 9.6 mm was mounted on the tip of the crosshead. The molding temperatures of the cylinder, the screw, and the crosshead were set to 100° C.

The substrate was transported at a transport speed while the feed speed was changed in order to form a crown shape, but the arithmetic mean speed when one charging roller was molded was adjusted to 47 mm/sec. Since the conductive rubber flowed out at the same speed as the core bar through a die outlet, the average flow rate when one roller was molded was 47 mm/sec, which was the same as the transport speed of the substrate.

The rotation speed of the screw was adjusted so that the outer diameter of the unvulcanized rubber roller was 9.7 mm at the longitudinal center, relative to the transport speed of the substrate. The molded unvulcanized rubber roller had a crown shape with an outer diameter of 9.8 mm at the longitudinal center and an outer diameter of 9.65 mm at positions +90 mm from the longitudinal center position to both ends.

Then, in an electric furnace, heating was performed at a temperature of 160° C. for 60 minutes, the unvulcanized rubber roller was vulcanized, and both ends were cut to produce a conductive elastic roller 20 in which the length of the conductive rubber formed in the axial direction was 232 mm.

TABLE 5

| | Region-B (core)-forming rubber composition (CMB) | | | | | | | | | |
|---|---|---|---|---|---|---|---|---|---|---|
| Region-B- | | | | | | Electron conducting agent | | | | |
| forming carbon | | | | | | | DBP | | | |
| masterbatch | Second rubber | | | | | | absorption | | | |
| CMB | Rubber | | Mooney | SP value | | | amount | | Zinc oxide | Zinc stearate |
| No. | type | Abbreviation | viscosity | (J/cm³)^{0.5} | Parts | Abbreviation | (cm³/100 g) | Parts | Parts | Parts |
| 1 | EPDM | E505A | 47 | 16.0 | 100 | #7360SB | 87 | 60 | 5 | 2 |
| 2 | IR | IR2200L | 70 | 16.5 | 100 | #7360SB | 87 | 60 | 5 | 2 |
| 3 | BR | BR150B | 40 | 16.8 | 100 | #7360SB | 87 | 60 | 5 | 2 |
| 4 | Butyl | Butyl 065 | 32 | 15.8 | 100 | #7360SB | 87 | 60 | 5 | 2 |
| 5 | EPDM | E505A | 47 | 16.0 | 100 | #7360SB | 87 | 30 | 5 | 2 |
| 6 | EPDM | E505A | 47 | 16.0 | 100 | #7360SB | 87 | 40 | 5 | 2 |
| 7 | EPDM | E505A | 47 | 16.0 | 100 | #7360SB | 87 | 80 | 5 | 2 |
| 8 | EPDM | E505A | 47 | 16.0 | 100 | Tin oxide | 87 | 60 | 5 | 2 |
| 9 | EPDM | E505A | 47 | 16.0 | 100 | #7270SB | 60 | 60 | 5 | 2 |
| 10 | EPDM | E505A | 47 | 16.0 | 100 | #5500 | 155 | 60 | 5 | 2 |

TABLE 6

| Matrix- and | | | | | | | | | | | | | | |
|---|---|---|---|---|---|---|---|---|---|---|---|---|---|---|
| region-C- | | | | | | | | | | | | | | |
| forming | | | | | | | | | | | | | | |
| rubber | Matrix- and region-C (shell)-forming rubber composition (MSC) | | | | | | | | | | | | | |
| composition | First rubber | | | | | Third rubber | | | | | Filler | | Zinc | Zinc |
| MSC | Rubber | Abbre- | Mooney | SP value | | Rubber | Abbre- | Mooney | SP value | | Abbre- | | oxide | stearate |
| No. | type | viation | viscosity | (J/cm³)^{0.5} | Parts | type | viation | viscosity | (J/cm³)^{0.5} | Parts | viation | Parts | Parts | Parts |
| 1 | NBR | N230SV | 32 | 20.0 | 80 | SBR | T2003 | 33 | 17.0 | 20 | #30 | 40 | 5 | 2 |
| 2 | CR | B31 | 40 | 17.4 | 80 | SBR | T2003 | 33 | 17.0 | 20 | #30 | 40 | 5 | 2 |
| 3 | NBR | N230SV | 32 | 20.0 | 80 | IR | IR2200L | 70 | 16.5 | 20 | #30 | 40 | 5 | 2 |
| 4 | NBR | N230SV | 32 | 20.0 | 80 | BR | BR150B | 40 | 16.8 | 20 | #30 | 40 | 5 | 2 |
| 5 | NBR | N230SV | 32 | 20.0 | 80 | SBR | T2003 | 33 | 17.0 | 20 | #30 | 40 | 5 | 2 |
| 6 | NBR | N230SV | 32 | 20.0 | 80 | EPDM | E505A | 47 | 16.0 | 20 | #30 | 40 | 5 | 2 |
| 7 | NBR | N230SV | 32 | 20.0 | 90 | SBR | T2003 | 33 | 17.0 | 10 | #30 | 40 | 5 | 2 |
| 8 | NBR | N230SV | 32 | 20.0 | 70 | SBR | T2003 | 33 | 17.0 | 30 | #30 | 40 | 5 | 2 |
| 9 | NBR | N230SV | 32 | 20.0 | 60 | SBR | T2003 | 33 | 17.0 | 40 | #30 | 40 | 5 | 2 |

### 3. Formation of Surface Layer

### 3-1. Preparation of Surface-layer-forming Coating Solution 1

A surface-layer-forming coating solution 1 for forming a surface layer was prepared as follows.

Under a nitrogen atmosphere, in a reaction container, 100 parts by mass of polycarbonate polyol (product name: T5652, commercially available from Asahi Kasei Chemicals Corporation) was gradually added dropwise to 27 parts by mass of polymeric MIDI (product name: Millionate MR200, commercially available from Asahi Kasei Chemicals Corporation) while the temperature in the reaction container was maintained at 65° C. After dropwise addition was completed, the mixture was reacted at a temperature of 65° C. for 2 hours. The obtained reaction mixture was cooled to room temperature to obtain a polycarbonate polyol/polymeric MDI prepolymer B-1.

54.0 parts by mass of a polycarbonate-based polyol/polymeric MDI prepolymer B-1, 46.0 parts by mass of a polycarbonate-based polyol (product name: T5652, commercially available from Asahi Kasei Chemicals Corporation), and 23 parts by mass of carbon black (product name: MA230, commercially available from Mitsubishi Chemical Corporation, number average particle diameter of 30 nm) were dissolved in methyl ethyl ketone (MEK) and the solid content was adjusted to 27 mass %. Then, 0.1 parts by mass of a modified dimethyl silicone oil (product name: SH-28PA, commercially available from Toray Dow Corning Silicone Co., Ltd.) was added to produce a mixed solution 1.

270 parts by mass of the mixed solution 1 and 200 parts by mass of glass beads having an average particle size of 0.8 mm were put into a glass bottle with an inner capacity of 450 mL, and dispersed using a paint shaker disperser for 12 hours. After the dispersion, 15 parts by mass of urethane particles having an average particle diameter of 7.0 μm (product name: Dynamic Beads UCN-5070D, commercially available from Dainichiseika Color & Chemicals Mfg. Co., Ltd.) were added. Then, the mixture was additionally dispersed for 15 minutes, and the glass beads were removed to obtain a surface-layer-forming coating solution 1.

### 3-2. Preparation of Surface-Layer-Forming Coating Solutions 2 to 8, and 10

Surface-layer-forming coating solutions 2 to 10 were prepared in the same manner as in the surface-layer-forming coating solution 1 except that materials and formulation proportions were changed as shown in Table 7.

TABLE 7

| Surface- | | | | | | | | | | | | |
|---|---|---|---|---|---|---|---|---|---|---|---|---|
| layer- | | | Mass | Coarse particles | | | Electron conducting | | Silicon addition | | Ion conducting | |
| forming | | | ratio | | Volume | Addition | | Addition | | Addition | | Addition |
| coating | | | (polyol/ | | average | amount | | amount | | amount | | amount |
| solution | | Iso- | iso- | | particle | [parts by | | [parts by | | [parts by | | [parts by |
| No. | Polyol | cyanate | cyanate) | Type | size [μm] | mass] | Type | mass] | Type | mass] | Type | mass] |
| 1 | A-1 | B-1 | 46/54 | C-1 | 7 | 15 | CB | 23 | D-1 | 0.1 | — | — |
| 2 | A-1 | B-1 | 46/54 | — | — | — | CB | 23 | D-1 | 0.1 | — | — |
| 3 | A-1 | B-1 | 46/54 | C-1 | 7 | 15 | Tin | 10 | — | — | — | — |
| | | | | | | | oxide | | | | | |
| 4 | A-1 | B-1 | 46/54 | C-1 | 7 | 15 | CB | 23 | D-1 | 0.1 | E-1 | 1 |
| 5 | A-2 | B-2 | 43/57 | C-1 | 7 | 15 | CB | 23 | — | — | | — |
| 6 | A-3 | B-3 | 41/59 | C-1 | 7 | 15 | CB | 23 | D-1 | 0.1 | — | — |
| 7 | A-1 | B-1 | 46/54 | C-2 | 3 | 15 | CB | 23 | D-1 | 0.1 | — | — |
| 8 | A-1 | B-1 | 46/54 | C-3 | 30 | 15 | CB | 23 | D-1 | 0.1 | — | — |
| 9 | — | — | Poly- | C-1 | 7 | 15 | CB | 23 | — | — | — | — |
| | | | styrene | | | | | | | | | |
| | | | used | | | | | | | | | |
| 10 | A-2 | B-2 | 43/57 | C-1 | 7 | 15 | — | — | — | — | E-1 | 4 |

The abbreviations for polyols, isocyanates, coarse particles, silicone additives, and ion conducting agents in Table 7 are as follows.
A-1: polycarbonate polyol (product name: T5652, commercially available from Asahi Kasei Corporation)
A-2: polyester polyol (product name: P2010, commercially available from Kuraray Co., Ltd.)
A-3: ε-caprolactone modified polyol (product name: DC2016, commercially available from Daicel Corporation)
B-1: polycarbonate polyol/polymeric MDI (product name: T5652, commercially available from Asahi Kasei Corporation/product name: Millionate MR200, commercially available from Tosoh Corporation)
B-2: polyester polyol/polymeric MDI (product name: P3010, commercially available from Kuraray Co., Ltd./product name: Millionate MR200, commercially available from Tosoh Corporation)
B-3: isocyanate A/isocyanate B = 4:3 (product name: Vestana B1370, commercially available from Degussa AG/product name: Duranate TPA-880E, commercially available from Asahi Kasei Corporation)
C-1: urethane particles (product name: Dynamic Beads UCN-5070D, commercially available from Dainichiseika Color & Chemicals Mfg. Co., Ltd.)
C-2: urethane particles (product name: Art Pearl C-1000T, commercially available from Negami Chemical Industrial Co., Ltd.)
C-3: urethane particles (product name: Art Pearl C-200T, commercially available from Negami Chemical Industrial Co., Ltd.)
CB: carbon black (product name: MA230, commercially available from Mitsubishi Chemical Corporation)
D-1: modified dimethyl silicone oil (product name: SH28-PA, commercially available from Toray Dow Corning Silicone Co., Ltd.)
E-1: quaternary ammonium salt (product name: ADK CIZER LV-70, commercially available from ADEKA)

### 3.3. Preparation of Surface-Layer-Forming Coating Solution 9

Polystyrene (commercially available from Sigma-Aldrich, a weight average molecular weight of 350,000) was dissolved in MEK to a concentration of 12 mass %. 23 parts by mass of carbon black (product name: MA230, commercially available from Mitsubishi Chemical Corporation, a number average particle diameter of 30 nm) was added thereto, and a surface-layer-forming coating solution 9 was prepared in the same manner as in the surface-layer-forming coating solution 1 from the dispersion step onward.

### Example 1

The conductive elastic roller 1 was oriented with its longitudinal direction in the vertical direction and its upper end was gripped and immersed (dipped) in the surface-layer-forming coating solution 1 and pulled up. The immersion time for the dipping coating was 9 seconds, the roller pulling speed was adjusted so that the initial speed was 20 mm/sec and the final speed was 2 mm/sec, and the speed was changed linearly with time between 20 mm/sec and 2 mm/sec.

After coating, air-drying was performed at a temperature of 23° C. for 30 minutes. Next, in a hot air circulation dryer, drying was performed at a temperature of 80° C. for 1 hour, drying was performed at a temperature of 160° C. for 1 hour, and thus a dried coating film of the surface-layer-forming coating solution 1 was formed on the elastic layer.

In addition, the surface of the dried film was irradiated with ultraviolet rays (UV) with a wavelength of 254 nm so that the cumulative light dose was 9,000 mJ/cm², the skin layer on the outermost surface of the dried film was removed, and the surface layer in which conductive particles (carbon black) in the dried film were exposed to the outer surface was formed. As the ultraviolet light source, a low-pressure mercury lamp (commercially available from Toshiba Lighting & Technology Corporation) was used. Thus, a charging roller 1 according to Example 1 was produced.

### Examples 2 to 30

As shown in Table 8 and Table 9, charging rollers 2 to 30 were produced in the same manner as in Example 1 except that the raw material composition of the conductive elastic roller, the presence of the polishing step, the surface-layer-forming coating solution, and the presence of UV treatment were changed.

### 4. Property Evaluation

The charging rollers of the examples and the comparative examples were evaluated by the following methods.

### 4-1. Presence of Matrix Domain Structure

Using a microtome (product name: LeicaEMFCS, commercially available from Leica Microsystems), at a cutting temperature of −100° C., a section with a thickness of about 2 μm was cut out. The cutting was performed at the longitudinal center position in a direction perpendicular to the longitudinal direction of the charging roller. In order to suitably perform subsequent SEM observation, the obtained section was pretreated to obtain favorable contrast between the matrix, the region B, and the region C. Specifically, osmium tetroxide was used for staining. As the amount of double bonds and benzene rings in the rubber was larger, staining further proceeded, and thus it was possible to identify the type of rubber and the electron conducting agent.

The sample was cut at 60 nm intervals using an FIB-SEM (commercially available from FEI Co., Ltd.), and 3D stereoscopic images were acquired from the obtained cross sections. Images having a cubic shape with one side of 6 μm were acquired at 60 nm intervals. This operation was performed at positions of 0 T (surface-layer/elastic-layer interface), 0.3 T, 0.6 T, and 0.8 T from the surface-layer/elastic-layer interface toward the support, where T is the thickness of the elastic layer.

The obtained observation image was subjected to 8-bit grayscale conversion using an image processing analysis device (product name: LUZEX-AP, commercially available from Nireco) to obtain a monochrome image with 256 gradations, and the matrixes and domains were distinguished.

When a plurality of domains were dispersed in a matrix and the matrix had a continuous structure, it was determined that the sample had a matrix domain structure. When all of the four samples had a matrix domain structure, the elastic layer was determined to have a matrix domain structure (MD structure).

The results are shown in Table 8.

### 4-2. Proportion of Domain a

Among the samples obtained in 4-1, using samples prepared at positions of 0.3 T, 0.6 T, and 0.8 T from the surface-layer/elastic-layer interface toward the support direction, where T is the thickness of the elastic layer, the proportion of the domain A in which the region B was surrounded by the region C was calculated. Specifically, the proportion of the domain A was calculated for each of the three observation regions, and the arithmetic mean of these values was used.

In addition, the region B and the region C were distinguished as follows. First, the second rubber and the third rubber could be distinguished according to the staining treatment. The third rubber forming the region C contained no electron conducting agent, or if it did, the density of the electron conducting agent in the rubber was lower than in the second rubber forming the region B. Therefore, the region B and the region C were distinguished based on the presence of the electron conducting agent and its density.

Specifically, in order to construct a 3D image using the FIB-SEM, the third rubber region of the image observed at 60 nm intervals was divided into 1 μm×1 μm grid regions, and if the area of the electron conducting agent part relative to the third rubber part in the divided region was 0 to 5%, the region was determined as the region C. The results are shown in Table 8.

### 4-3. Proportion of Region B1

Among the samples obtained in 4-1, using the sample prepared at a position of 0 T (surface-layer/elastic-layer interface) from the surface-layer/elastic-layer interface toward the support, where T is the thickness of the elastic layer, the proportion (amount %) of the region B1 directly below which the region C was provided within the region B in the domain was calculated.

Specifically, the number of domains in which the region C was provided directly below the region B was calculated, relative to the total number of domains in contact with the surface layer, and the proportion thereof was calculated.

Here, when the region B was a domain and the region C was provided directly below the region B in 50% or more of the images among all images observed at 60 nm intervals in order to construct a 3D image using the FIB-SEM, it was determined that the region C was provided directly below the region B. That is, it could be determined that the region B included the region B1 in the electrophotographic member as a measurement target.

### 4-4. Thickness of Region C

The thickness of the region C provided directly below the region B in the domain in 4-3 was measured. For measurement, among all images observed at 60 nm intervals in order to construct a 3D image using the FIB-SEM, the thickness was calculated from each image in which the region C was provided directly below the region B, and the arithmetic mean of these values was used.

Here, in order to calculate the thickness of the region C in each image, the thicknesses at five points in the image were calculated, and the arithmetic mean of these values was calculated.

The results are shown in Table 8.

### 4-5. Measurement of Volume Resistivity of Matrix

Using a microtome (product name: LeicaEMFCS, commercially available from Leica Microsystems), a section with a thickness of about 2 μm was cut out at a cutting temperature of −100° C. The cutting was performed at the longitudinal center position of the charging roller in a direction perpendicular to the longitudinal direction of the charging roller.

The volume resistivity was measured using a scanning probe microscope (SPM) (product name: Q-Scope250, Quesant Instrument Corporation) in a contact mode as follows. Here, the measurement environment was a temperature of 23° C. and a relative humidity of 50%. The measurement was performed in a 15 μm square region at positions of 0 T (surface-layer/elastic-layer interface), 0.3 T, 0.6 T, and 0.8 T from the surface-layer/elastic-layer interface toward the support direction, where T is the thickness of the elastic layer.

The measurement method will be described in detail below. The section was placed on a metal plate so that one surface of the section corresponding to the cross section of the elastic layer was in contact with the surface of the metal plate. Then, an SPM cantilever was brought into contact with a part corresponding to the matrix within the surface of the section opposite to the surface in contact with the surface of the metal plate. Next, a voltage of 50 V was applied to the cantilever, and the current value was measured. In addition, the surface shape of the section was observed using the SPM, and the thickness of the measurement part was calculated from the obtained height profile. In addition, the area of the depressed portion of the contact part of the cantilever was calculated based on the observation result of the surface shape. The volume resistivity was calculated from the thickness and the area of the depressed portion and used as the volume resistivity of the matrix.

The results are shown in Table 8.

### 4-6. Measurement of Volume Resistivity of Region C in Domain a

In the same manner as in the above 4-5. Measurement of volume resistivity of matrix, a section was cut out. Next, the section was cut at 60 nm intervals using an FIB-SEM (commercially available from FEI Co., Ltd.), and the volume resistivity of the matrix was measured in the same manner as above except that the contact position of the cantilever with respect to the obtained cross section was changed to a position corresponding to the region C. The same step was repeated until the entire domain was completely cut. The 3D image using the FIB-SEM was analyzed using an image analysis device (product name: LUZEX-AP, commercially available from Nireco) to determine whether the region C surrounded the circumference of the region B and whether the domain was the domain A. In the case of the domain A, the volume resistivity of the region C in the cross section closest to the center of the volume was calculated.

The results are shown in Table 8.

### 4-7. Measurement of Volume Resistivity of Region B in Domain a

The measurement was performed in the same manner as in the above 4-6. Measurement of volume resistivity of region C in domain A except that the contact position of the cantilever was set to a position corresponding to the region B in the domain A, and a voltage applied to the cantilever was set to 1 V.

The results are shown in Table 8.

### 4-8. Proportion of Cross-Sectional Area of Conductive Particles in Region B

The section for which 4-2. Proportion of domain A was calculated was imaged at a magnification of 20,000 using a scanning electron microscope (SEM) (product name: S-4800, commercially available from Hitachi High-Tech Corporation) to obtain a cross section image. Next, using image analysis software (product name: ImageProPlus, commercially available from Media Cybernetics), binarization was performed so that the electron conducting agent in the region B in the domain A could be distinguished. In addition, an observation region with a sufficient size to contain one domain was extracted from the obtained binary image, and using a counting function of the software, the cross-sectional area S of the region B in the domain A and the cross-sectional area Sc of carbon black as conductive particles contained in the region B were calculated. This operation was performed on nine domains A, and the proportion of the cross-sectional area of the conductive particles in the region B was calculated from the arithmetic mean value of Sc/S.

The results are shown in Table 8.

### 4-9. Measurement of Shape of Region B in Domain a

The section for which 4-2. Proportion of domain A was calculated was imaged at a magnification of 10,000 using a scanning electron microscope (SEM) (product name: S-4800, commercially available from Hitachi High-Tech Corporation) to obtain a cross section image. A 15 μm square region was extracted as an analysis image, and in order to quantify the shape of the domain in the analysis image, 8-bit grayscale conversion was performed using image processing software ImageProPlus (product name, commercially available from MediaCybernetics) to obtain a monochrome image with 256 gradations. Next, black and white in the image were inverted so that the region B in the fracture surface appeared white, and a binary image was obtained. Next, using the counting function on the binary image, the following items were calculated for the region B group present in the binary image.
Arithmetic mean distance between regions B (μm)
Perimeter S1 (μm)
Enveloped perimeter S2 (μm)

The arithmetic mean value of the values obtained by dividing the perimeter S1 by the enveloped perimeter S2 was used as an index of the shape of the region B in the domain A.

The results are shown in Table 8.

### 4-10. Measurement of Thickness of Surface Layer

The thickness of the surface layer was measured by observing the cross section of the surface layer at three points in the axial direction and three points in the circumferential direction (a total of nine points) using an optical microscope or an electron microscope, and the arithmetic mean of these values was taken as “thickness” of the surface layer.

The results are shown in Table 9.

### 4-11. Measurement of Universal Hardness of Surface Layer

The universal hardness at a position with a depth of 1 μm from the surface of the surface layer was measured using a universal hardness tester. For the measurement, an ultra-micro hardness tester (product name: FISCHERSCOPE HM-2000, commercially available from Helmut Fischer GmBH) was used. Specific measurement conditions were as follows.
Measurement indenter: Vickers indenter (a face angle of 136°, a Young's modulus of 1,140 GPa, a Poisson's ratio of 0.07, indenter material: diamond)
Measurement environment: A temperature of 23° C., a relative humidity of 50%
Maximum test load: 1.0 mN
Loading conditions: The load was applied proportionally to the time at a rate that reached the maximum test load in 30 seconds. In this evaluation, the universal hardness was calculated by the following Calculation Formula (1) using the load F when the indenter was pressed to a depth of 1 μm from the surface of the surface layer and the contact area A between the indenter and the surface layer at that time.

$$universal hardness ( N / {mm}^{2} ) = F / A \qquad Calculation Formula ( 1 )$$

The results are shown in Table 9.

### 4-12. Measurement of Volume Resistivity of Surface Layer

The volume resistivity of the surface layer was measured using an atomic force microscope (AFM) (product name: Q-scope250: commercially available from Quesant) in a conductivity mode. First, the surface layer of the charging roller was cut into a sheet with a width of 2 mm and a length of 2 mm using a manipulator, and platinum was deposited on one surface of the surface layer. Next, a DC power source (product name: 6614C, commercially available from Agilent) was connected to the platinum-deposited surface, 10 V was applied, the free end of the cantilever was brought into contact with the other surface of the surface layer, and a current image was obtained through the AFM main body. This measurement was performed at 100 randomly selected points on the surface of the entire surface layer, and the “volume resistivity” was calculated from the average current value of the 10 lowest current values and the average value of the thicknesses of the surface layer.

Measurement conditions were as follows.
Measurement mode: contact
Cantilever: CSC17
Measurement range: 10 μm×10 μm
Scan rate: 4 Hz
Applied voltage: 10 V

The results are shown in Table 9.

### 4-13. Measurement of Protruded Portion Derived from Exposed Part of Electron Conducting Agent on Outer Surface of Surface Layer

The method of measuring the number of protruded portions derived from the exposed part of the electron conducting agent on the surface of the surface layer was as follows. First, the elastic layer including the surface layer was cut out from the charging roller. Next, a height image was acquired by performing tapping measurement with a cantilever over a region of 2.0 μm length×2.0 μm width using a scanning probe microscope (SPM) (product name: MFP-3D-Origin, commercially available from Asylum Technology). The obtained height image was processed using image processing software (product name: Igor-Pro, commercially available from HULINKS Inc.), protruded portions of 5 nm or more in the height image were extracted according to binarization processing, and the number of protruded portions was calculated. SPM height images were acquired at five points, and the arithmetic mean value of the calculated numbers of particles that formed protrusions was used as the number of protruded portions derived from the exposed part of the electron conducting agent of the present disclosure.

The measurement conditions were as follows.
Measurement mode: AM-FM mode tapping measurement
Cantilever: SI-DF3
Measurement range: 2 μm×2 μm

The results are shown in Table 9.

### 5. Evaluation of Charging Member

Hereinafter, the method of evaluating the charging roller 1 will be exemplified. For the charging rollers 2 to 30, the same measurement procedure as in the charging roller 1 was performed.

### 5-1. Measurement of Quantity of Charge Injected into Toner

The ability of the charging roller 1 to supply negative charge to contaminant components (contaminant components such as transfer residual toner and external additives) was evaluated as follows.

As the electrophotographic image forming apparatus, a laser printer (product name: HP LaserJet Pro M203dw, commercially available from HP) was prepared. Then, the motor of this laser printer was modified so that the process speed became 1.6 times the normal speed. In addition, an external power source was connected in order to apply a voltage to the charging roller and modification was performed so that the voltage was not applied directly to the charging roller from the main body. In addition, the cleaning blade for the charging roller and the developer container that comes into contact with the photosensitive drum were removed from the process cartridge of this laser printer. In addition, the transfer roller of the laser printer main body was also removed.

The laser printer and the process cartridge were left in a low temperature and low humidity (a temperature of 15° C. and a relative humidity of 10%) environment for 48 hours. Next, the process cartridge was loaded into the laser printer. Then, the following evaluation was performed in a low temperature and low humidity environment. In the low temperature and low humidity environment, injection of charge into the toner from the charging roller was unlikely to occur. When the following evaluation was performed in such an environment, the ability of injecting charge into the charging roller could be more accurately evaluated.

First, the main body was stopped during an image formation step in which one solid black image was output under normal image output conditions, and a state in which the entire circumference of the photosensitive drum was covered with a toner layer was formed.

Next, the process cartridge in which the entire circumference of the photosensitive drum was covered with the toner layer was removed from the main body. The charging roller of this process cartridge was removed, the charging roller 1 was mounted as the charging roller, and this process cartridge was mounted in the main body.

Then, a voltage at which the charging roller was not discharged, specifically-500 V, was applied to the charging roller 1 from an external power source, an image step in which one solid white image was output was performed, and during this step, the potential of the toner on the surface of the toner layer on the photosensitive drum was measured before and after passing through the nip part between the charging roller and the photosensitive drum. The potential was measured using a surface potential meter probe (product name: MODEL 555P-1, commercially available from Trek Japan Co., Ltd.) placed at a position 2 mm away from the surface of the photosensitive drum.

The difference between the surface potential of the toner layer before passing through the nip part and the surface potential of the toner layer after passing through the nip part was measured as the quantity of charge (V) injected from the charging roller into the toner.

The results are shown in Table 9.

### 5-2. Measurement of Amount of Contaminants (Toner Color Density)

In order to evaluate the amount of contaminants adhered to the charging roller 1, the following evaluation was performed.

As the electrophotographic image forming apparatus, a laser printer (product name: HP LaserJet Pro M203dw, commercially available from HP) was prepared. Then, the motor of this laser printer was modified so that the process speed became 1.6 times the normal speed. In addition, an external power source was connected in order to apply a voltage to the charging roller and modification was performed so that the voltage was not applied directly to the charging roller from the main body. In addition, the cleaning blade of the charging roller was removed from the process cartridge of this laser printer. The evaluation environment was the same as in the above 5-1. Measurement of quantity of charge injected into toner.

First, 500 images, each depicting horizontal lines, 2 dots wide and spaced 100 dots apart in the direction perpendicular to the rotation direction of the photosensitive drum, were output, the charging roller 1 was removed from the process cartridge, and its degree of contamination was evaluated by tape coloration evaluation. The tape coloration evaluation was performed as follows.

A polyester adhesive tape (product name: No. 31B, commercially available from Nitto Denko Corporation) was adhered to the surface of the charging roller, and the adhesive tape was then peeled off together with the toner adhered to the surface of the charging roller, and adhered to a sheet of white paper. This procedure was performed over the entire image printing region on the surface of the charging roller, the reflection density of the adhesive tape was then measured over the entire image printing region using a photovolt reflection densitometer (product name: TC-6DS/A, commercially available from Tokyo Denshoku Co., Ltd.), and the maximum value was determined. Next, in the same manner, the reflection density of a new polyester adhesive tape adhered to a sheet of white paper was measured to determine the minimum value, and an increment in the reflection density was used as the value of the color density. Since a smaller color density value indicated a smaller amount of contamination on the charging roller and better performance, the color density was used as an index of the degree of contamination on the charging roller. The results are shown in Table 9.

### 5-3. Measurement of Charge Decay Property

When the matrix has a predetermined volume resistivity, it is possible to inhibit the phenomenon in which the above contaminant substance acquires charge with the opposite polarity to charge that charges the photosensitive member. If the matrix is insulating, when opposite-polarity charge moves from the surface layer toward the core bar, charge does not move toward the core bar in the matrix part, and thus the above very strong electric field causes abnormally excessive discharge, and white spot images are easily formed.

As the ability to inhibit the phenomenon in which the contaminant substance acquires charge with the opposite polarity to charge that charges the photosensitive member, the charge decay property was measured. The surface of the charging roller 1 was once positively charged, and as the charge moved toward the core bar, the potential decreased. The charge decay property was evaluated based on the amount that surface potential decreased over a predetermined time.

Specifically, the surface potential of the charging roller through corona discharge was measured using a charge quantity measuring device (product name: DRA-2000L, commercially available from QEA). Specifically, a corona discharger of the charge quantity measuring device was arranged such that the gap between the grid part and the surface of the charging roller was 1 mm. Next, a voltage of 8 kV was applied to the corona discharger to generate discharge, the surface of the charging roller was charged, and the surface potential immediately after charging (immediately after discharging was completed) and the surface potential of the charging roller after 10 seconds were measured.

The surface potential immediately after charging was defined as E0, the surface potential 10 seconds after discharging was completed (or after charging was completed) was defined as E10, and the charge decay rate Q (%) was calculated by the following Formula (7).

$$Q = \{ ( E 0 - E 10 ) / E 0 \} \times 100 \qquad ( 7 )$$

The results are shown in Table 9.

### 5-4. Image Evaluation

In the same main body and cartridge configuration as in the above 5-2. Measurement of amount of contaminants (toner color density), in a low temperature and low humidity (a temperature of 15° C. and a relative humidity of 10%) environment, 20,000 images in which the alphabet letter “E” in a 4-point size was printed on A4-size paper with a print percentage of 1% were output. Here, the electrophotographic image was output in a so-called intermittent mode in which the rotation of the electrophotographic photoreceptor was stopped for 7 seconds whenever one sheet was output. In image output in the intermittent mode, compared to continuous electrophotographic image output, the number of times the charging roller and the electrophotographic photoreceptor rubbed against each other increased, making harsher evaluation conditions for the charging roller.

Next, a halftone image (image depicting horizontal lines, 1 dot wide and spaced 2 dots apart in the direction perpendicular to the rotation direction of the photosensitive drum) was output, and the obtained image was observed visually and with a magnifier, and evaluated based on the following criteria.
Rank A: No white spots were observed at all even when checked with a magnifier.
Rank B: No white spots were visible.
Rank C: A few white spots were visible.
Rank D: White spots were visible across the entire region.

The results are shown in Table 9.

TABLE 8

| | | Conductive | | | | | | Coating | UV | Presence |
|---|---|---|---|---|---|---|---|---|---|---|
| Ex- | Charging | elastic roller | MSC | CMB | MSC | CMB | Polishing | solution | treat | of MD |
| ample | roller No. | No. | No. | No. | Parts | Parts | step | No. | ment | structure |
| 1 | 1 | 1 | 1 | 1 | 74 | 26 | Yes | 1 | Yes | Yes |
| 2 | 2 | 2 | 2 | 1 | 74 | 26 | Yes | 1 | Yes | Yes |
| 3 | 3 | 3 | 3 | 1 | 74 | 26 | Yes | 1 | Yes | Yes |
| 4 | 4 | 4 | 4 | 1 | 74 | 26 | Yes | 1 | Yes | Yes |
| 5 | 5 | 5 | 5 | 2 | 74 | 26 | Yes | 1 | Yes | Yes |
| 6 | 6 | 6 | 5 | 3 | 74 | 26 | Yes | 1 | Yes | Yes |
| 7 | 7 | 7 | 5 | 4 | 74 | 26 | Yes | 1 | Yes | Yes |
| 8 | 8 | 8 | 6 | 4 | 74 | 26 | Yes | 1 | Yes | Yes |
| 9 | 9 | 9 | 5 | 5 | 74 | 26 | Yes | 1 | Yes | Yes |
| 10 | 10 | 10 | 5 | 6 | 74 | 26 | Yes | 1 | Yes | Yes |
| 11 | 11 | 11 | 5 | 7 | 74 | 26 | Yes | 1 | Yes | Yes |
| 12 | 12 | 12 | 5 | 8 | 74 | 26 | Yes | 1 | Yes | Yes |
| 13 | 13 | 13 | 5 | 1 | 82 | 18 | Yes | 1 | Yes | Yes |
| 14 | 14 | 14 | 5 | 1 | 64 | 36 | Yes | 1 | Yes | Yes |
| 15 | 15 | 15 | 7 | 1 | 74 | 26 | Yes | 1 | Yes | Yes |
| 16 | 16 | 16 | 8 | 1 | 74 | 26 | Yes | 1 | Yes | Yes |
| 17 | 17 | 17 | 9 | 1 | 74 | 26 | Yes | 1 | Yes | Yes |
| 18 | 18 | 18 | 5 | 9 | 74 | 26 | Yes | 1 | Yes | Yes |
| 19 | 19 | 19 | 5 | 10 | 74 | 26 | Yes | 1 | Yes | Yes |
| 20 | 20 | 1 | 1 | 1 | 74 | 26 | Yes | 1 | No | Yes |
| 21 | 21 | 1 | 1 | 1 | 74 | 26 | Yes | 2 | Yes | Yes |
| 22 | 22 | 1 | 1 | 1 | 74 | 26 | Yes | 3 | Yes | Yes |
| 23 | 23 | 1 | 1 | 1 | 74 | 26 | Yes | 4 | Yes | Yes |
| 24 | 24 | 1 | 1 | 1 | 74 | 26 | Yes | 5 | Yes | Yes |
| 25 | 25 | 1 | 1 | 1 | 74 | 26 | Yes | 6 | Yes | Yes |
| 26 | 26 | 1 | 1 | 1 | 74 | 26 | Yes | 7 | Yes | Yes |
| 27 | 27 | 1 | 1 | 1 | 74 | 26 | Yes | 8 | Yes | Yes |
| 28 | 28 | 1 | 1 | 1 | 74 | 26 | Yes | 9 | Yes | Yes |
| 29 | 29 | 1 | 1 | 1 | 74 | 26 | Yes | 10 | Yes | Yes |
| 30 | 30 | 20 | 1 | 1 | 74 | 26 | No | 1 | Yes | Yes |

| | | | Thickness | | | | Proportion of | | |
|---|---|---|---|---|---|---|---|---|---|
| | | | of | | | | cross-sectional | Arithmetic | |
| | | | region C | | Volume | Volume | area of | mean | |
| | Proportion | Proportion | directly | Volume | resistivity | resistivity | electron | distance | Shape |
| | of | of | below | resistivity | of | of | conducting | between | index of |
| Ex- | domain A | region B1 | region B1 | of matrix | region C | region B | agent in region | regions B | region B |
| ample | [amount %] | [amount %] | [μm] | [Ωcm] | [Ωcm] | [Ωcm] | B [%] | [μm] | S1/S2 |
| 1 | 71 | 64 | 0.20 | 2.3E+09 | 8.3E+13 | 6.1E+01 | 26.0 | 0.54 | 1.07 |
| 2 | 70 | 63 | 0.13 | 5.3E+10 | 7.9E+13 | 4.6E+01 | 26.3 | 0.20 | 1.05 |
| 3 | 55 | 50 | 0.25 | 2.0E+09 | 8.4E+15 | 5.3E+01 | 26.1 | 0.44 | 1.07 |
| 4 | 64 | 58 | 0.21 | 2.1E+09 | 3.1E+15 | 6.4E+01 | 26.0 | 0.48 | 1.05 |
| 5 | 54 | 49 | 0.25 | 2.0E+09 | 8.1E+13 | 5.5E+01 | 26.2 | 0.44 | 1.06 |
| 6 | 45 | 41 | 0.23 | 1.9E+09 | 7.8E+13 | 4.8E+01 | 26.2 | 0.42 | 1.07 |
| 7 | 90 | 81 | 0.26 | 2.0E+09 | 8.3E+13 | 4.4E+01 | 25.9 | 1.06 | 1.06 |
| 8 | 48 | 43 | 0.28 | 2.0E+09 | 3.4E+16 | 4.3E+01 | 25.6 | 0.96 | 1.07 |
| 9 | 72 | 65 | 0.23 | 2.3E+09 | 8.5E+13 | 4.9E+01 | 19.4 | 0.54 | 1.12 |
| 10 | 70 | 63 | 0.26 | 2.2E+09 | 8.3E+13 | 4.2E+03 | 20.7 | 0.52 | 1.10 |
| 11 | 73 | 66 | 0.26 | 2.2E+09 | 8.1E+13 | 2.1E+01 | 27.4 | 0.54 | 1.02 |
| 12 | 71 | 64 | 0.25 | 2.2E+09 | 8.1E+13 | 5.7E+01 | 26.0 | 0.60 | 1.10 |
| 13 | 86 | 77 | 0.42 | 2.3E+09 | 8.7E+13 | 5.9E+01 | 26.1 | 1.44 | 1.05 |
| 14 | 51 | 46 | 0.20 | 2.0E+09 | 7.7E+13 | 4.8E+01 | 26.0 | 0.42 | 1.05 |
| 15 | 58 | 52 | 0.18 | 1.9E+09 | 8.6E+13 | 4.9E+01 | 25.9 | 0.60 | 1.05 |
| 16 | 78 | 70 | 0.33 | 2.1E+09 | 8.8E+13 | 5.3E+01 | 26.3 | 0.56 | 1.07 |
| 17 | 84 | 76 | 0.54 | 2.1E+09 | 9.0E+13 | 4.8E+01 | 26.1 | 0.58 | 1.04 |
| 18 | 71 | 64 | 0.26 | 2.3E+09 | 8.5E+13 | 8.3E+01 | 27.0 | 0.62 | 1.01 |
| 19 | 70 | 63 | 0.25 | 2.3E+09 | 8.5E+13 | 1.5E+01 | 26.5 | 0.52 | 1.10 |
| 20 | 71 | 64 | 0.20 | 2.4E+09 | 8.2E+13 | 6.1E+01 | 26.0 | 0.54 | 1.07 |
| 21 | 72 | 65 | 0.22 | 2.3E+09 | 8.6E+13 | 6.2E+01 | 26.2 | 0.52 | 1.07 |
| 22 | 71 | 64 | 0.19 | 2.2E+09 | 8.1E+13 | 6.7E+01 | 26.0 | 0.50 | 1.07 |
| 23 | 71 | 64 | 0.20 | 2.5E+09 | 8.0E+13 | 6.2E+01 | 26.1 | 0.50 | 1.07 |
| 24 | 73 | 66 | 0.20 | 2.3E+09 | 8.2E+13 | 6.5E+01 | 26.3 | 0.54 | 1.07 |
| 25 | 72 | 65 | 0.21 | 2.4E+09 | 8.4E+13 | 6.0E+01 | 26.0 | 0.56 | 1.07 |
| 26 | 71 | 64 | 0.18 | 2.2E+09 | 8.3E+13 | 6.3E+01 | 26.1 | 0.48 | 1.07 |
| 27 | 72 | 65 | 0.20 | 2.2E+09 | 8.3E+13 | 6.2E+01 | 26.2 | 0.50 | 1.07 |
| 28 | 72 | 65 | 0.18 | 2.3E+09 | 8.5E+13 | 6.4E+01 | 26.5 | 0.52 | 1.07 |
| 29 | 71 | 64 | 0.22 | 2.5E+09 | 8.0E+13 | 6.4E+01 | 26.1 | 0.56 | 1.07 |
| 30 | 74 | 67 | 0.33 | 2.3E+09 | 8.1E+13 | 7.0E+01 | 27.0 | 0.66 | 1.07 |

TABLE 9

| | Charging | Conductive | | | | | | Coating | |
|---|---|---|---|---|---|---|---|---|---|
| Ex- | roller | elastic roller | MSC | CMB | MSC | CMB | Polishing | solution | UV |
| ample | No. | No. | No. | No. | Parts | Parts | step | No. | treatment |
| 1 | 1 | 1 | 1 | 1 | 74 | 26 | Yes | 1 | Yes |
| 2 | 2 | 2 | 2 | 1 | 74 | 26 | Yes | 1 | Yes |
| 3 | 3 | 3 | 3 | 1 | 74 | 26 | Yes | 1 | Yes |
| 4 | 4 | 4 | 4 | 1 | 74 | 26 | Yes | 1 | Yes |
| 5 | 5 | 5 | 5 | 2 | 74 | 26 | Yes | 1 | Yes |
| 6 | 6 | 6 | 5 | 3 | 74 | 26 | Yes | 1 | Yes |
| 7 | 7 | 7 | 5 | 4 | 74 | 26 | Yes | 1 | Yes |
| 8 | 8 | 8 | 6 | 4 | 74 | 26 | Yes | 1 | Yes |
| 9 | 9 | 9 | 5 | 5 | 74 | 26 | Yes | 1 | Yes |
| 10 | 10 | 10 | 5 | 6 | 74 | 26 | Yes | 1 | Yes |
| 11 | 11 | 11 | 5 | 7 | 74 | 26 | Yes | 1 | Yes |
| 12 | 12 | 12 | 5 | 8 | 74 | 26 | Yes | 1 | Yes |
| 13 | 13 | 13 | 5 | 1 | 82 | 18 | Yes | 1 | Yes |
| 14 | 14 | 14 | 5 | 1 | 64 | 36 | Yes | 1 | Yes |
| 15 | 15 | 15 | 7 | 1 | 74 | 26 | Yes | 1 | Yes |
| 16 | 16 | 16 | 8 | 1 | 74 | 26 | Yes | 1 | Yes |
| 17 | 17 | 17 | 9 | 1 | 74 | 26 | Yes | 1 | Yes |
| 18 | 18 | 18 | 5 | 9 | 74 | 26 | Yes | 1 | Yes |
| 19 | 19 | 19 | 5 | 10 | 74 | 26 | Yes | 1 | Yes |
| 20 | 20 | 1 | 1 | 1 | 74 | 26 | Yes | 1 | No |
| 21 | 21 | 1 | 1 | 1 | 74 | 26 | Yes | 2 | Yes |
| 22 | 22 | 1 | 1 | 1 | 74 | 26 | Yes | 3 | Yes |
| 23 | 23 | 1 | 1 | 1 | 74 | 26 | Yes | 4 | Yes |
| 24 | 24 | 1 | 1 | 1 | 74 | 26 | Yes | 5 | Yes |
| 25 | 25 | 1 | 1 | 1 | 74 | 26 | Yes | 6 | Yes |
| 26 | 26 | 1 | 1 | 1 | 74 | 26 | Yes | 7 | Yes |
| 27 | 27 | 1 | 1 | 1 | 74 | 26 | Yes | 8 | Yes |
| 28 | 28 | 1 | 1 | 1 | 74 | 26 | Yes | 9 | Yes |
| 29 | 29 | 1 | 1 | 1 | 74 | 26 | Yes | 10 | Yes |
| 30 | 30 | 20 | 1 | 1 | 74 | 26 | No | 1 | Yes |

| | Surface layer | | | | | | | |
|---|---|---|---|---|---|---|---|---|
| | | | | Number of fine | Quantity | | Charge | |
| | Thick- | Universal | Volume | protrusions | of charge | Toner | decay | |
| Ex- | ness | hardness | resistivity | derived from | injected | color | property | Image |
| ample | [μm] | [N/mm²] | [Ωcm] | conducting agent | [V] | density [%] | [%] | rank |
| 1 | 10 | 3.2 | 6.50E+10 | 230 | −24.7 | 10 | 80 | A |
| 2 | 15 | 3.2 | 6.50E+10 | 230 | −22.2 | 15 | 66 | B |
| 3 | 10 | 3.2 | 6.50E+10 | 230 | −18.4 | 27 | 81 | B |
| 4 | 10 | 3.2 | 6.50E+10 | 230 | −21.9 | 20 | 82 | B |
| 5 | 10 | 3.2 | 6.50E+10 | 230 | −18.0 | 28 | 80 | B |
| 6 | 10 | 3.2 | 6.50E+10 | 230 | −14.5 | 35 | 83 | C |
| 7 | 10 | 3.2 | 6.50E+10 | 230 | −32.1 | 5 | 81 | A |
| 8 | 10 | 3.2 | 6.50E+10 | 230 | −15.7 | 33 | 77 | C |
| 9 | 10 | 3.2 | 6.50E+10 | 230 | −25.0 | 14 | 86 | A |
| 10 | 10 | 3.2 | 6.50E+10 | 230 | −22.8 | 20 | 81 | A |
| 11 | 10 | 3.2 | 6.50E+10 | 230 | −25.4 | 13 | 88 | A |
| 12 | 10 | 3.2 | 6.50E+10 | 230 | −24.7 | 15 | 79 | A |
| 13 | 10 | 3.2 | 6.50E+10 | 230 | −30.5 | 6 | 82 | A |
| 14 | 10 | 3.2 | 6.50E+10 | 230 | −16.9 | 34 | 81 | B |
| 15 | 10 | 3.2 | 6.50E+10 | 230 | −19.6 | 25 | 81 | B |
| 16 | 10 | 3.2 | 6.50E+10 | 230 | −27.4 | 9 | 79 | A |
| 17 | 10 | 3.2 | 6.50E+10 | 230 | −29.7 | 8 | 78 | A |
| 18 | 10 | 3.2 | 6.50E+10 | 230 | −24.7 | 15 | 80 | A |
| 19 | 10 | 3.2 | 6.50E+10 | 230 | −24.3 | 15 | 80 | A |
| 20 | 10 | 3.2 | 7.90E+10 | 0 | −13.0 | 40 | 75 | C |
| 21 | 10 | 2.4 | 5.70E+10 | 230 | −25.0 | 14 | 81 | A |
| 22 | 20 | 5.0 | 1.20E+10 | 160 | −19.6 | 25 | 86 | B |
| 23 | 15 | 1.8 | 2.10E+10 | 220 | −24.7 | 15 | 88 | A |
| 24 | 12 | 3.4 | 3.40E+10 | 210 | −22.0 | 20 | 84 | B |
| 25 | 8 | 25.0 | 1.50E+12 | 180 | −15.8 | 37 | 72 | C |
| 26 | 10 | 3.2 | 6.60E+10 | 230 | −24.7 | 15 | 80 | A |
| 27 | 10 | 2.6 | 6.20E+10 | 230 | −25.0 | 14 | 81 | A |
| 28 | 25 | 5.2 | 4.50E+12 | 65 | −16.0 | 32 | 70 | C |
| 29 | 5 | 1.0 | 8.80E+11 | 0 | −12.1 | 42 | 72 | C |
| 30 | 10 | 3.2 | 6.50E+10 | 230 | −25.8 | 12 | 86 | A |

Here, in the tables, the notation 2.3E+09 indicates 2.3×10⁹.

### Comparative Example 1

### Production of Conductive Elastic Roller 21

Materials of types and formulation amounts shown in Table 10 were mixed using a 6-liter pressure kneader (product name: TD6-15MDX, commercially available from Toshin Inc.) to obtain a carbon masterbatch 11 (CMB11). The mixing conditions were a filling rate of 70 vol %, a blade rotation speed of 30 rpm, a temperature of 130° C. in the kneader, and 16 minutes.

TABLE 10

| | | Formulation |
|---|---|---|
| | Material name | amount (parts |
| | (abbreviation) | by mass) |
| Second rubber | N230V | 100 |
| Electron | #7270SB | 70 |
| conducting agent | | |
| Vulcanization | Zinc oxide | 5 |
| acceleration aid | | |
| Processing aid | SZ-2000 | 2 |

Next, materials of types and formulation amounts shown in Table 11 were mixed using a 6-liter pressure kneader (product name: TD6-15MDX, commercially available from Toshin Inc.) to obtain a matrix-forming rubber composition 10 (MSC10). The mixing conditions were a filling rate of 70 vol %, a blade rotation speed of 30 rpm, a temperature of 100° C. in the kneader, and 16 minutes.

TABLE 11

| | | Formulation |
|---|---|---|
| | Material name | amount (parts |
| | (abbreviation) | by mass) |
| First rubber | T2003 | 100 |
| Third rubber | — | — |
| Filler | #30 | 40 |
| Vulcanization | Zinc oxide | 5 |
| acceleration aid | | |
| Processing aid | SZ-2000 | 2 |

Then, materials of types and formulation amounts shown in Table 12 were mixed using an open roller to obtain a conductive-elastic-layer-forming unvulcanized rubber composition 21.

As a mixer, an open roller with a roll diameter of 12 inches was used. The mixing conditions were as follows: the front roll rotation speed was 10 rpm, the rear roll rotation speed was 8 rpm, the roll gap was 2 mm, and after performing a total of 20 left-and-right reversals, the roll gap was reduced to 1.0 mm, and 10 thin passes were performed.

Then, molding was performed in the same manner as in the conductive elastic roller 1 to produce a conductive elastic roller 21.

TABLE 12

| | | Formulation |
|---|---|---|
| | Material name | amount (parts |
| | (abbreviation) | by mass) |
| Raw material | Carbon masterbatch | 25 |
| rubber | 11 (CMB11) | |
| Raw material | Matrix-forming rubber | 75 |
| rubber | composition 10 (MSC10) | |
| Vulcanizing | PMC | 3 |
| agent | | |
| Vulcanization | TBzTD | 1 |
| accelerator 1 | | |
| Vulcanization | TBSI | 0.5 |
| accelerator 2 | | |

### Production of Charging Roller 31

A charging roller 31 was produced in the same manner as in Example 1 except that the conductive elastic roller 21 was used and a surface-layer-forming coating solution 5 was used.

The results are shown in Tables 15 and 16.

### Comparative Example 2

### Production of Charging Roller 32

A charging roller 32 was produced in the same manner as in the charging roller 31 except that the carbon masterbatch was changed to a CMB 12 formed from materials shown in Table 13, and the matrix-forming material was changed to an MSC 10 formed from materials shown in Table 14.

The results are shown in Tables 15 and 16.

TABLE 13

| | | Formulation |
|---|---|---|
| | Material name | amount (parts |
| | (abbreviation) | by mass) |
| Second rubber | T2003 | 100 |
| Electron | #7270SB | 70 |
| conducting agent | | |
| Vulcanization | Zinc oxide | 5 |
| acceleration aid | | |
| Processing aid | SZ-2000 | 2 |

TABLE 14

| | | Formulation |
|---|---|---|
| | Material name | amount (parts |
| | (abbreviation) | by mass) |
| First rubber | N230SV | 100 |
| Third rubber | — | — |
| Filler | #30 | 40 |
| Vulcanization | Zinc oxide | 5 |
| acceleration aid | | |
| Processing aid | SZ-2000 | 2 |

TABLE 15

| Compara- | | Conductive | | | | | | Coating | | Presence |
|---|---|---|---|---|---|---|---|---|---|---|
| tive | Charging | elastic roller | MSC | CMB | MSC | CMB | Polishing | solution | UV | of MD |
| Example | roller No. | No | No. | No. | Parts | Parts | step | No. | treatment | structure |
| 1 | 31 | 21 | 10 | 11 | 75 | 25 | Yes | 5 | Yes | Yes |
| 2 | 32 | 22 | 11 | 12 | 75 | 25 | Yes | 5 | Yes | Yes |

| | | | Thickness | | | | Proportion of | Arithmetic | |
|---|---|---|---|---|---|---|---|---|---|
| | | | of | | Volume | Volume | cross-sectional | mean | |
| | | | region C | Volume | resistivity | resistivity | area of electron | distance | Shape |
| | Proportion of | Proportion | directly | resistivity of | of | of | conducting | between | index of |
| Comparative | domain A | of region B1 | below region | matrix | region C | region B | agent in region | regions B | region B |
| Example | [amount %] | [amount %] | B1 [μm] | [Ωcm] | [Ωcm] | [Ωcm] | B [%] | [μm] | S1/S2 |
| 1 | — | — | — | 8.3E+13 | — | 8.1E+01 | 28.0 | 0.64 | 1.08 |
| 2 | — | — | — | 2.9E+08 | — | 9.6E+01 | 26.7 | 0.58 | 1.09 |

TABLE 16

| | | Conductive | | | | | | Coating | |
|---|---|---|---|---|---|---|---|---|---|
| Comparative | Charging | elastic roller | MSC | CMB | MSC | CMB | Polishing | solution | UV |
| Example | roller No. | No. | No. | No. | Parts | Parts | step | No. | treatment |
| 1 | 31 | 21 | 10 | 11 | 75 | 25 | Yes | 5 | Yes |
| 2 | 32 | 22 | 11 | 12 | 75 | 25 | Yes | 5 | Yes |

| | Surface layer | | | | | | | |
|---|---|---|---|---|---|---|---|---|
| | | | | Number of fine | | Toner | Charge | |
| | | Universal | Volume | protrusions | Quantity of | color | decay | |
| Comparative | Thickness | hardness | resistivity | derived from | charge | density | property | |
| Example | [μm] | [N/mm²] | [Ωcm] | conducting agent | injected [V] | [%] | [%] | Image rank |
| 1 | 20 | 3.2 | 6.80E+10 | 210 | −23.0 | 25 | 41 | D |
| 2 | 20 | 3.2 | 6.80E+10 | 210 | −9.9 | 52 | 76 | D |

According to the present disclosure, it is possible to obtain an electrophotographic member that can maintain high-image quality for a long period even when applied to a high-speed and cleanerless electrophotographic image forming process. In addition, according to another aspect of the present disclosure, it is possible to obtain an electrophotographic image forming apparatus that can stably output a high-quality electrophotographic image, and a process cartridge used therein.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-014069, filed Jan. 30, 2025, which is hereby incorporated by reference herein in its entirety.

What is claimed is:

1. An electrophotographic member, comprising:
a support having a conductive outer surface;
an elastic layer provided on the outer surface side of the support; and
a surface layer provided on the outer surface of the elastic layer,
wherein the elastic layer includes
a matrix containing a first rubber;
a plurality of regions B in the matrix; and
a plurality of regions C in the matrix,
a volume resistivity of the matrix is 1.0×10⁸ to 1.0×10¹² Ω·cm,
the region B contains a second rubber different from the first rubber and an electron conducting agent, and has a volume resistivity of 1.0×10⁴ Ω·cm or less,
the region C contains a third rubber different from both the first rubber and the second rubber and has a volume resistivity of 1.0×10¹² Ω·cm or more,
in cross-sectional observation of a cross section perpendicular to a longitudinal direction of the electrophotographic member, at least a part of the region B includes a region B1, and
the region B1 is a domain dispersed in the matrix, in contact with the surface layer, and is a region where the region C exists directly below.

2. The electrophotographic member according to claim 1, wherein the domain including the region B and/or the region C is dispersed in the matrix, and at least a part of the domain is a domain A having a structure in which the region B is surrounded by the region C.

3. The electrophotographic member according to claim 2, wherein a proportion of the domain A in the domains in the cross-sectional observation is 50 amount % or more.

4. The electrophotographic member according to claim 2, wherein a proportion of the domain A in the domains in the cross-sectional observation is 70 amount % or more.

5. The electrophotographic member according to claim 2, wherein, in the cross-sectional observation, when a perimeter of the region B in the domain A is S1 and an enveloped perimeter is S2, S1 and S2 satisfy Formula (1):
$$1. 00 \leq S 1 / S 2 \leq 1 \text{.10} . \qquad ( 1 )$$

6. The electrophotographic member according to claim 2, wherein, in the cross-sectional observation, an arithmetic mean value Db of the distances between the regions B in the domain A is 0.20 to 2.00 μm.

7. The electrophotographic member according to claim 1, wherein, in the cross-sectional observation, a proportion of a cross-sectional area of the electron conducting agent contained in the region B with respect to a cross-sectional area of the region B is 20.0 area % or more.

8. The electrophotographic member according to claim 1, wherein the electron conducting agent contains carbon black.

9. The electrophotographic member according to claim 1, wherein a thickness of the region C existing directly below the region B1 is 0.30 μm or less.

10. The electrophotographic member according to claim 1, wherein the first rubber is at least one rubber selected from the group consisting of acrylonitrile butadiene rubber and chloroprene rubber.

11. The electrophotographic member according to claim 1, wherein the second rubber is at least one rubber selected from the group consisting of butadiene rubber, butyl rubber, isoprene rubber and ethylene propylene diene rubber.

12. The electrophotographic member according to claim 1, wherein the third rubber is at least one rubber selected from the group consisting of butadiene rubber, isoprene rubber, styrene butadiene rubber, and ethylene propylene diene rubber.

13. The electrophotographic member according to claim 1, wherein the surface layer contains a binder resin and an electron conducting agent dispersed in the binder resin,
a surface of the surface layer has a protruded portion derived from an exposed part of the electron conducting agent, and a universal hardness at a position with a depth of 1 μm from the surface of the surface layer is 1.0 to 7.0 N/mm².

14. The electrophotographic member according to claim 13, wherein the electron conducting agent dispersed in the surface layer contains carbon black.

15. The electrophotographic member according to claim 13, wherein the binder resin has a polycarbonate structure.

16. The electrophotographic member according to claim 1, wherein the surface layer contains a polyurethane resin.

17. The electrophotographic member according to claim 1, wherein the surface layer contains coarse particles having a number average particle diameter of 3.0 to 30.0 μm.

18. A process cartridge detachable from a main body of an electrophotographic image forming apparatus, wherein the process cartridge includes an electrophotographic photoreceptor and a charging member that is arranged so that it is able to charge the electrophotographic photoreceptor,
the charging member comprises:
a support having a conductive outer surface;
an elastic layer provided on the outer surface side of the support; and
a surface layer provided on the outer surface of the elastic layer,
the elastic layer includes
a matrix containing a first rubber;
a plurality of regions B in the matrix; and
a plurality of regions C in the matrix,
a volume resistivity of the matrix is 1.0×10⁸ to 1.0×10¹² Ω·cm,
the region B contains a second rubber different from the first rubber and an electron conducting agent, and has a volume resistivity of 1.0×10⁴ Ω·cm or less,
the region C contains a third rubber different from both the first rubber and the second rubber and has a volume resistivity of 1.0×10¹² Ω·cm or more,
in cross-sectional observation of a cross section perpendicular to a longitudinal direction of the electrophotographic member, at least a part of the region B includes a region B1, and
the region B1 is a domain dispersed in the matrix, in contact with the surface layer, and is a region where the region C exists directly below.

19. An electrophotographic image forming apparatus, comprising:
an electrophotographic photoreceptor; and
a charging roller that is arranged so that it is able to charge the electrophotographic photoreceptor, wherein
the charging roller comprises:
a support having a conductive outer surface;
an elastic layer provided on the outer surface side of the support; and
a surface layer provided on the outer surface of the elastic layer,
the elastic layer includes
a matrix containing a first rubber;
a plurality of regions B in the matrix; and
a plurality of regions C in the matrix;
a volume resistivity of the matrix is 1.0×10⁸ to 1.0×10¹² Ω·cm,
the region B contains a second rubber different from the first rubber and an electron conducting agent, and has a volume resistivity of 1.0×10⁴ Ω·cm or less,
the region C contains a third rubber different from both the first rubber and the second rubber and has a volume resistivity of 1.0×10¹² Ω·cm or more,
in cross-sectional observation of a cross section perpendicular to a longitudinal direction of the electrophotographic member, at least a part of the region B includes a region B1, and
the region B1 is a domain dispersed in the matrix, in contact with the surface layer, and is a region where the region C exists directly below.
